(19) United States
(12) Patent Application Publication
(10) Pub. No.: US 2013/0321717 A1
(43) Pub. Date: Dec. 5, 2013

(54) LIGHTING DEVICE, DISPLAY DEVICE AND TELEVISION DEVICE

(71) Applicant: Yasumori Kuromizu, Osaka-shi (JP)

(72) Inventor: Yasumori Kuromizu, Osaka-shi (JP)

(73) Assignee: SHARP KABUSHIKI KAISHA, Osaka-shi, Osaka (JP)

(21) Appl. No.: 13/985,332

(22) PCT Filed: Mar. 9, 2012
(86) PCT No.: PCT/JP2012/056106

§ 371 Date: Aug. 14, 2013

(30) Foreign Application Priority Data
Mar. 18, 2011 (JP) 2011-061078

(51) Int. Cl. F21V 7/05; G02F 1/1335

(52) U.S. Cl. CPC F21V 7/05; G02F 1/133608
USPC 348/790; 362/235; 362/97.1; 349/67

(57) ABSTRACT

The backlight unit 12 according to this invention includes a plurality of LEDs 24, an LED board 25, a reflection sheet 29, a chassis 22, a first attachment member 31, and a second attachment member 32. The LED board 25 has a first board insertion hole 25c and a second board insertion hole 25d. The second board insertion hole 25d is arranged closer to an end portion of the LED board 25 in an arranging direction of the LEDs 24 than the first board insertion hole 25c. The reflection sheet 29 has a first reflection sheet insertion hole 29d and a second reflection sheet insertion hole 29e. The first attachment member 31 has a first axial portion 31b and a first head portion 31a. The first axial portion 31b is passed through the first board insertion hole 25c. The first head portion 31a is fixed at a hole edge of the first board insertion hole 25c. The second attachment member 32 has a second axial portion 32b and a second head portion 32a. The second axial portion 32b is passed through the second reflection sheet insertion hole 29e and the second board insertion hole 25b. The second head portion 32a is stopped at a hole edge of the second reflection sheet insertion hole 29e.

### TECHNICAL FIELD

The present invention relates to a lighting device, a display device, and a television device.

### BACKGROUND ART

Displays in image display devices, such as television devices, are now being shifted from conventional cathode-ray tube displays to thin displays, such as liquid crystal displays and plasma displays. Liquid crystal panels do not emit light. If the liquid crystal panels are used as display components, backlight units are required as separate lighting devices.

Patent Document 1 discloses a backlight unit including a plurality of light sources arranged on a substrate, a reflection sheet arranged on a non-light source arrangement area of the substrate, a screw and a nut (fixing members) fixing the substrate and the reflection sheet, and a stopper (a holding member) holding the substrate and the reflection sheet. In the backlight unit, the substrate and the reflection sheet are fixed together to the chassis by the nut and the screw (the fixing members) and held to the chassis by the stopper (the holding member).

### RELATED ART DOCUMENT

### Patent Document

Patent Document 1: Japanese Unexamined Patent Application Publication No. 2009-87879

### Problem to be Solved by the Invention

A backlight is generally assembled by the following procedures. First, a substrate provided with a light source thereon is placed on a chassis and then a reflection sheet is placed on the substrate. After the reflection sheet is placed on the substrate, the substrate and the reflection sheet are attached together to the chassis by an attachment member such as a stopper. However, the substrate may shift from the placed position on the chassis before the attachment member is attached thereto. This shifting of the substrate is more likely to occur in a large backlight unit because the large backlight unit requires a large number of substrates and, accordingly, requires a large number of assembling procedures.

In such a case, only the substrate may be fixed to the chassis by a first attachment member. Then, the reflection sheet may be arranged on the substrate and the reflection sheet and the substrate may be fixed together to the chassis by a second attachment member. To prevent the first attachment member interfering with the reflection sheet, a through hole may be provided to the reflection sheet at a portion corresponding to the first attachment member. The reflection sheet is arranged with the first attachment member being passed through the through hole.

However, the first attachment member does not fix the reflection sheet to the chassis. If the first attachment member is arranged at an edge portion of the reflection sheet, the edge portion of the reflection sheet is not firmly fixed to the chassis. As a result, the reflection sheet may lift at the edge portion thereof. Moreover, the surface of such a substrate that is exposed from the through hole generally has lower light reflectivity than the reflection sheet. If a plurality of the light sources are arranged close to one another, those areas may be recognized as dark spots.

### DISCLOSURE OF THE PRESENT INVENTION

This invention was made in view of the above circumstances. An object of this invention is to provide a lighting device including a first attachment member for attachment of a board and a second attachment member for attachment of reflection sheet and substrate such that uneven brightness is less likely to occur therein. Another object of this invention is to provide a display device and a television device each including the lighting device.

### Means for Solving the Problem

To solve the above problem, a lighting device includes a plurality of light sources, a board, a reflection sheet, a chassis, a first attachment member, and a second attachment member. The board includes the light sources mounted on one of surfaces thereof and arranged along an arranging direction of the light sources. The board has a first board insertion hole and a second board insertion hole. The second board insertion hole is arranged closer to an end portion of the board in the arranging direction of the light sources than the first board insertion hole. The reflection sheet is arranged on the one of the surfaces of the board. The reflection sheet has a first reflection sheet insertion hole and a second reflection sheet insertion hole. The first reflection sheet insertion hole is arranged at a position that overlaps with the first board insertion hole and has a diameter larger than a diameter of the first board insertion hole. The second reflection sheet insertion hole is arranged at a position that overlaps with the second board insertion hole. The chassis houses the board and the reflection sheet. The first attachment member is for fixing the board to the chassis. The first attachment member has a first axial portion and a first head portion. The first axial portion is passed through the first board insertion hole and fixed to the chassis. The first head portion has a diameter larger than the diameter of the first board insertion hole and smaller than the diameter of the first reflection sheet insertion hole. The first head portion is fixed at a hole edge of the first board insertion hole. The second attachment member is for fixing the reflection sheet and the board to the chassis. The second attachment member has a second axial portion and a second head portion. The second axial portion is passed through the second reflection sheet insertion hole and the second board insertion hole and fixed to the chassis. The second head portion has a diameter larger than a diameter of the second reflection sheet insertion hole and is fixed at a hole edge of the second reflection sheet insertion hole.

In general, if the reflection sheet is fluctuated, the reflection sheet reflects light to different directions and this may cause uneven brightness in the lighting device. An edge portion of the reflection sheet is more likely to lift from the chassis and this may be a factor of fluctuation. In this invention, the second attachment member is located at the end portion of the board. The second attachment member fixes not only the board but also the reflection sheet to the chassis. Therefore, at least a part of the board that is located at the edge portion of the chassis is attached to the chassis with the second attachment member. Namely, the reflection sheet is also attached to the chassis at apart corresponding to the edge portion of the chassis with the second attachment member. Thus, the reflection sheet is less likely to lift from the edge portion of the chassis. On the other hand, the first attachment member does not have a function to attach the reflection sheet to the chassis. If the first attachment member is attached to the end portion of the board, apart of the reflection sheet that is located at the edge portion of the chassis may lift from the chassis and this may cause uneven brightness.

According to this invention, more than two boards are arranged along the arranging direction of the light sources. The second attachment members are attached to the end portions of the boards. Therefore, the first reflection sheet insertion holes are not arranged close to each other at end portions of the adjacent boards. Accordingly, dark spots that may be caused by the first reflection insertion holes are less likely to be visible. If the first attachment members are arranged at the end portions of the adjacent boards, the first attachment members are located close to each other and dark spots caused by the first attachment members may be easily visible. Specifically, the head portion of the first attachment member is passed through the first reflection sheet insertion hole. Therefore, the surface of the board, which has lower light reflectivity than the reflection sheet, is exposed from the first reflection sheet insertion hole. If the first attachment members are arranged close to each other, the exposed parts of the surface of the boards are located close to each other and dark spots may be easily visible. On the other hand, the second attachment member has the second head portion of which diameter is larger than that of the second reflection sheet insertion hole. Therefore, the second head portion can cover the second reflection sheet insertion hole. Thus, areas around the second attachment members are less likely visible as dark spots.

In the above configurations, the board further includes a plurality of boards housed in the chassis. At least one of the board arranged at a corner portion inside the chassis is attached to the chassis by the first attachment member and the second attachment member.

With such a configuration, the second attachment member fixes the board and the reflection sheet to the corner portion of the chassis. Thus, uplift of the reflection sheet is suppressed or less likely to occur at the corner portion of the chassis.

According to the above configurations, the second attachment member further includes a plurality of second attachment members and the boards are arranged along the arranging direction of the light sources. Each of the boards is provided with the second attachment member that is arranged at an end portion thereof opposite an end portion of an adjacent board arranged along the arranging direction of the light sources.

With such a configuration, at the opposite end portions of the two adjacent boards arranged along the arranging direction of the light sources, at least two second attachment members are arranged between the two first attachment members that are respectively arranged on the respective adjacent boards. Thus, the first attachment members can be arranged away from each other. Thus, uneven brightness, which may be cause by the first reflection sheet insertion holes arranged close to each other, is less likely to occur.

In the above configurations, the boards are arranged perpendicular to the arranging direction of the light sources. The first attachment member further includes a plurality of first attachment members. Each one of the first attachment members is arranged to each one of the boards such that the first attachment members are in line with each other in an arranging direction of the boards.

With such a configuration, if the attaching work for the first attachment members is performed along the arranging direction of the boards, the previously attached first attachment member and the subsequently attaching first attachment member are located adjacent to each other along the arranging direction of the boards. Thus, the attachment work of the first attachment members can be easily performed. In addition, if a jig for attaching a plurality of the first members at once is used, the jig can have a linear configuration. Further, the jig can be used from a direction perpendicular to the direction in which the first attachment members are linearly aligned.

In the above configurations, the boards are arranged perpendicular to the arranging direction of the light sources. The first attachment members are arranged to the adjacent boards along the arranging direction of the boards such that the first attachment members are in a staggered position with each other.

With such a configuration, the first attachment members are less likely to be arranged close to each other. The reflection sheet insertion holes, which may cause dark spots, are also less likely to be arranged close to each other. Therefore, uneven brightness, which may be caused the first reflection sheet insertion holes, is less likely to occur.

In the above configurations, each of the first attachment members and the second attachment members has a same configuration and includes a same piece.

With such a configuration, the same first and second pieces can be used for the first and second attachment members only by providing the first and second reflection sheet insertion holes having different diameters. Thus, the number of parts can be reduced.

In the above configurations, the lighting device further includes an optical member arranged opposite the reflection sheet to diffuse light. The second attachment member includes a second attachment member having a support portion.

With such a configuration, the support portion is included in the second attachment member. Therefore, the arranging work for the reflection sheet is easily performed. If the support portion is included in the first attachment member, the projected support portion may be an obstruction in arrangement work for the reflection sheet. According to this embodiment, the projected support portion does not obstacle for arranging the reflection sheet.

In the above configurations, the board is attached to the chassis with two of the first attachment members.

With such a configuration, the boards are fixed to the chassis with the first attachment members, at first. Then, the reflection sheet and the boards are fixed to the chassis with the second attachment members. In this attachment procedure, each board can be fixed to the chassis without being shifted from the arranged position by the first attachment member. Further, the number of the first reflection sheet insertion holes, which may be recognized as dark spots, can be reduced to the minimum necessary.

Next, to solve the above problem, a display device of this invention may include the above lighting device and a display panel configured to provide display using light from the lighting device.

The display panel may be a liquid crystal panel using liquid crystals. The display device as a liquid crystal display device has a variety of applications, such as a television display or a personal-computer display. In particular, it is suitable for a large screen display.

Next, to solve the above problem, a television device of this invention may include the above display device.

### Advantageous Effect of the Invention

According to present invention, a lighting device including a first attachment member that fixes a substrate to a chassis and a second attachment member that fixes a reflection sheet and the substrate to the chassis that can suppress uneven brightness.

### BRIEF DESCRIPTION OF THE DRAWINGS

FIG. 1 is an exploded perspective view illustrating a general configuration of a television device according to a first embodiment of this invention.

FIG. 2 is an exploded perspective view illustrating a general configuration of a liquid crystal display device.

FIG. 3 is a cross-sectional view of a liquid crystal panel taken along a long-side direction thereof illustrating a cross-sectional configuration.

FIG. 4 is a magnified plan view of an array board illustrating a plan-view configuration.

FIG. 5 is a magnified plan view of a CF board illustrating a plan-view configuration.

FIG. 6 is a plan view illustrating an arrangement of diffuser lenses, LED boards, and holding members in a chassis included in a backlight unit.

FIG. 7 is a cross-sectional view of the liquid crystal display device taken along a short-side direction thereof illustrating a cross-sectional configuration.

FIG. 8 is a cross-sectional view of the liquid crystal display device taken along a long-side direction thereof illustrating a cross-sectional configuration.

FIG. 9 is a magnified plan view illustrating an arrangement of a first attachment member and a second attachment member in an end portion of an LED board.

FIG. 10 is a magnified cross-sectional view illustrating an arrangement of the first attachment members and the second attachment members in the end portion of the LED board (a cross-sectional view taken along line A-A in FIG. 9).

FIG. 11 is a magnified cross-sectional view illustrating attachment conditions of the first attachment member and the second attachment member.

FIG. 12 is a magnified plan view illustrating an arrangement of the first attachment members and the second attachment member in a corner portion of the chassis.

FIG. 13 is a magnified plan view illustrating an arrangement of the first attachment members and the second attachment members in a middle area of the chassis.

FIG. 14 is a magnified plan view illustrating an arrangement of the first attachment members in an end portion of the chassis.

FIG. 15 is an exploded cross-sectional view illustrating an attachment structure of the first attachment member.

FIG. 16 is an exploded cross-sectional view illustrating an attachment structure of a reflection sheet.

FIG. 17 is an exploded cross-sectional view illustrating an attachment structure of the second attachment member.

FIG. 18 is a cross-sectional view illustrating attachment condition of the first attachment member, the reflection sheet, and the second attachment member.

FIG. 19 is a magnified plan view illustrating an arrangement of first attachment members in an end portion of a chassis according to a second embodiment of this invention.

FIG. 20 is a plan view illustrating an arrangement of diffuser lenses, LED boards, and holding members in a chassis included in a backlight unit according to a third embodiment of this invention.

FIG. 21 is a magnified view of a CF board according to other embodiment (1) illustrating a plan-view configuration.

FIG. 22 is a magnified view of a CF board according to other embodiment (2) illustrating a plan-view configuration.

FIG. 23 is a magnified view of a CF board according to other embodiment (3) illustrating a plan-view configuration.

FIG. 24 is a magnified view of a CF board according to other embodiment (4) illustrating a plan-view configuration.

FIG. 25 is a magnified view of a CF board according to other embodiment (5) illustrating a plan-view configuration.

FIG. 26 is a magnified view of a CF board according to other embodiment (6) illustrating a plan-view configuration.

FIG. 27 is a magnified view of an array board according to other embodiment (6) illustrating a plan-view configuration.

FIG. 28 is a magnified view of a CF board according to other embodiment (7) illustrating a plan-view configuration.

FIG. 29 is a magnified view of a CF board according to other embodiment (8) illustrating a plan-view configuration.

FIG. 30 is a magnified view of an array board according to other embodiment (8) illustrating a plan-view configuration.

FIG. 31 is a magnified view of a CF board according to other embodiment (11) illustrating a plan-view configuration.

FIG. 32 is a magnified view of an array board according to other embodiment (12) illustrating a plan-view configuration.

FIG. 33 is a magnified view of a CF board according to other embodiment (12) illustrating a plan-view configuration.

### MODE FOR CARRYING OUT THE INVENTION

### First Embodiment

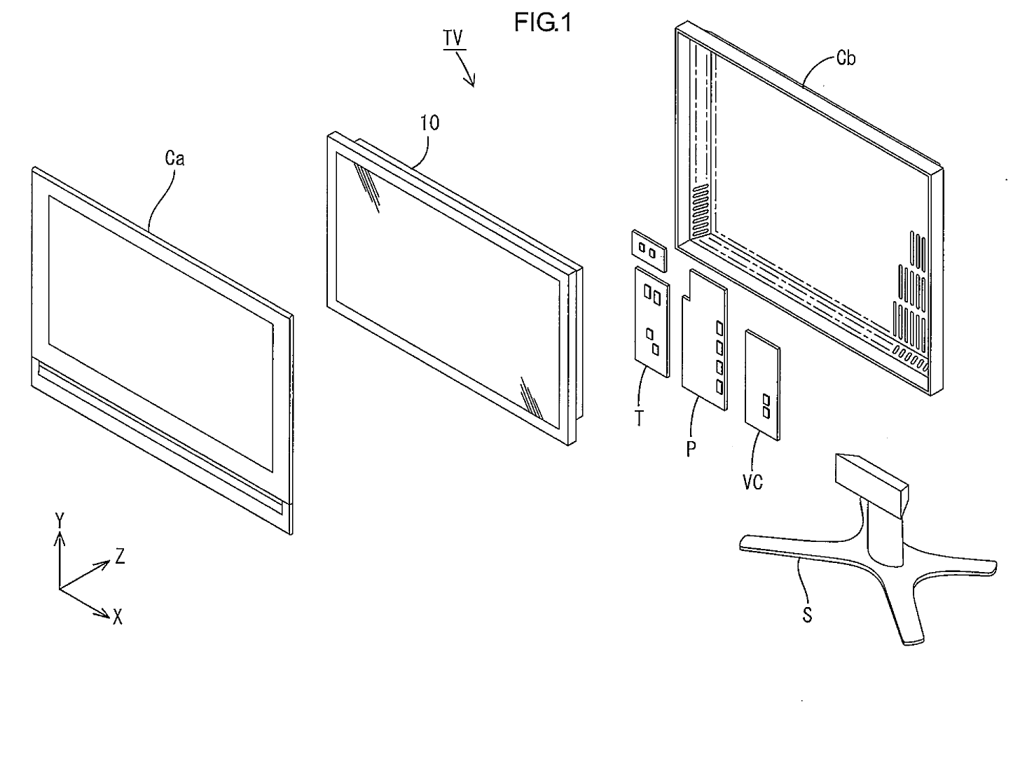

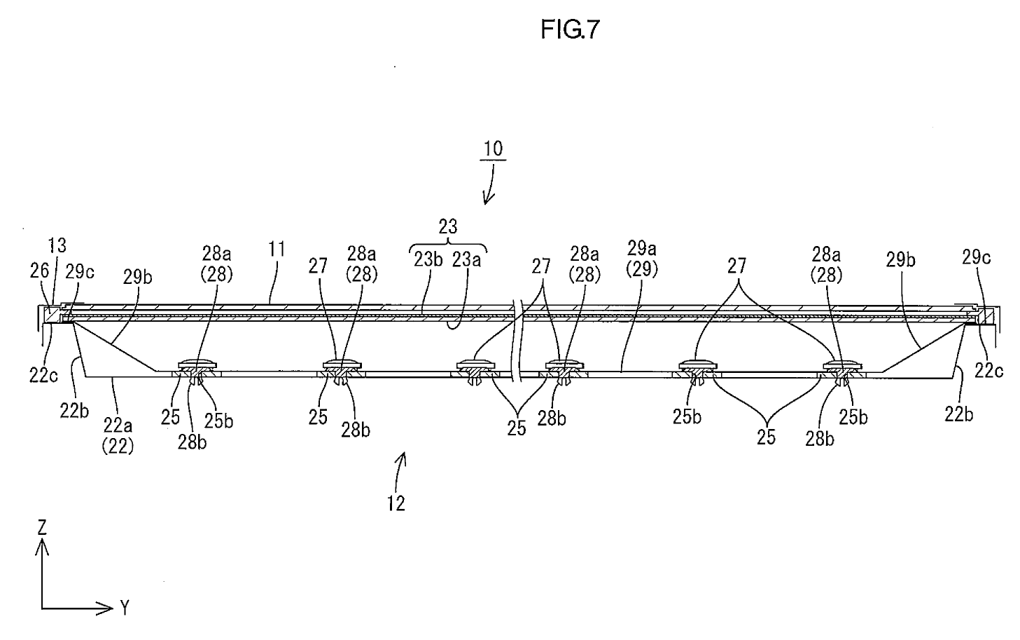

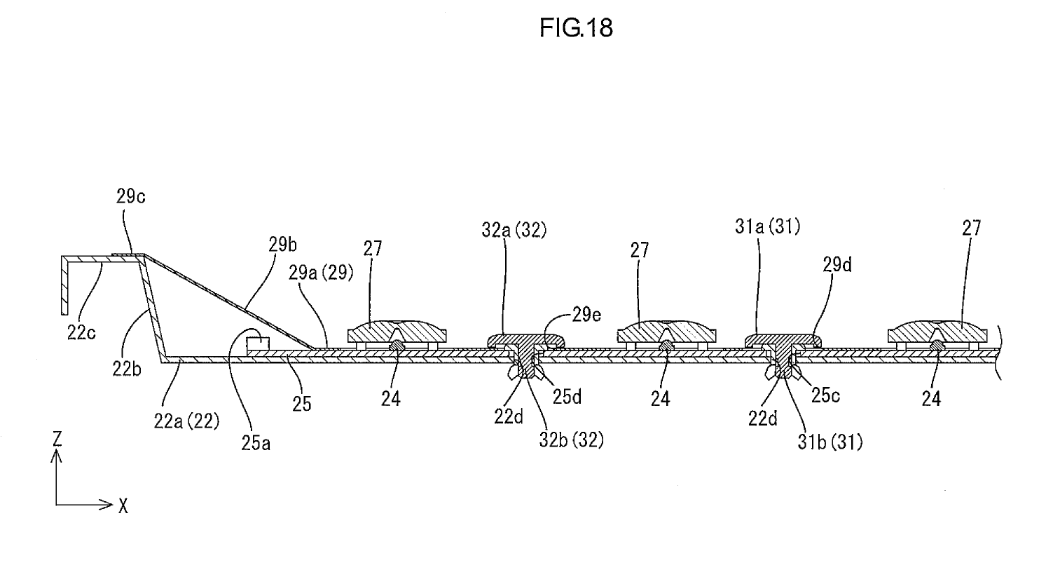

A first embodiment of the present invention will be described with reference to FIGS. 1 to 18. In this embodiment, a liquid crystal display device 10 will be explained. X-axes, Y-axes, and Z-axes are in some drawings. Directions indicated by the axes in each drawing correspond to directions indicated by the respective axes in other drawings. An upper side in FIG. 7 corresponds to a front-surface side and a lower side in FIG. 7 corresponds to a rear-surface side.

(Television Device)

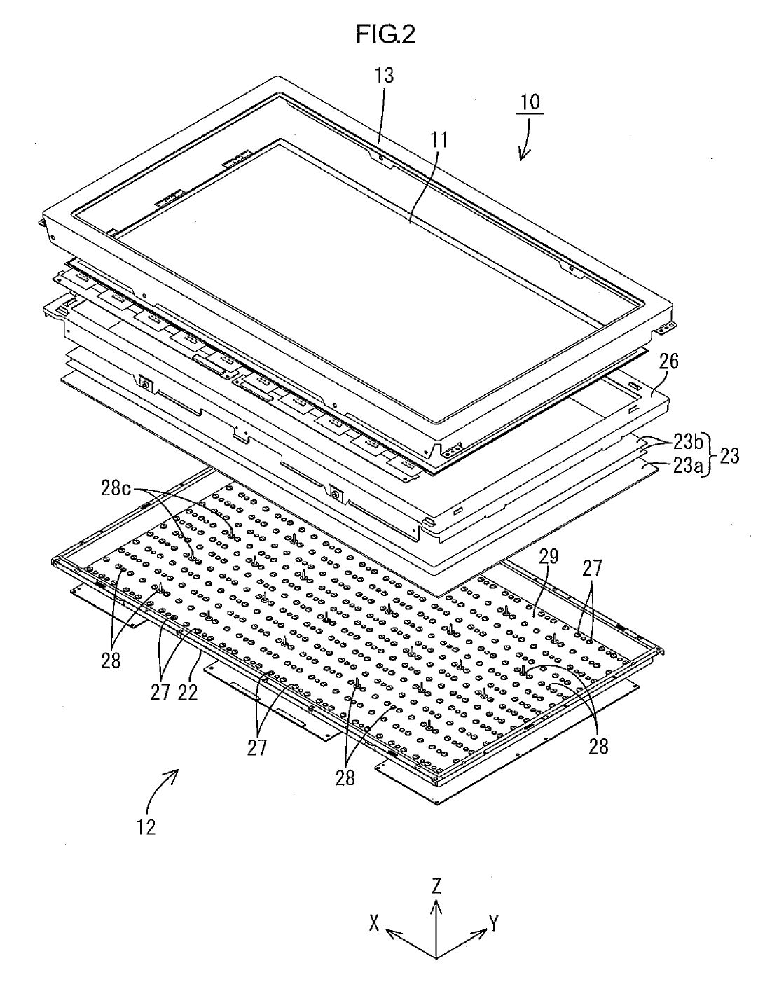

As illustrated in FIG. 1, a television device TV of this embodiment includes the liquid crystal display device 10, front and rear cabinets Ca, Cb which house the liquid crystal display device 10 therebetween, a power supply circuit board P for supplying electric power, a tuner T (a receiver), an image converter circuit board VC, and a stand S. The tuner T is configured to receive a television image signal. The image converter circuit board VC is configured to convert the television image signal received from the tuner T into an image signal for the liquid crystal display device 10. An overall shape of the liquid crystal display device 10 is a landscape rectangular (a rectangular shape). The liquid crystal display device 10 is held with the long-side direction thereof substantially aligned with the horizontal direction (the X-axis direction) and the short-side direction thereof substantially aligned with the vertical direction (the Y-axis direction). As illustrated in FIG. 2, the liquid crystal display device 10 includes a liquid crystal panel 11 as a display panel, and a backlight unit 12 (a lighting device) as an external light source. The liquid crystal panel 11 and the backlight unit 12 are integrally held by a frame shaped bezel 13, for example.

(Liquid Crystal Panel)

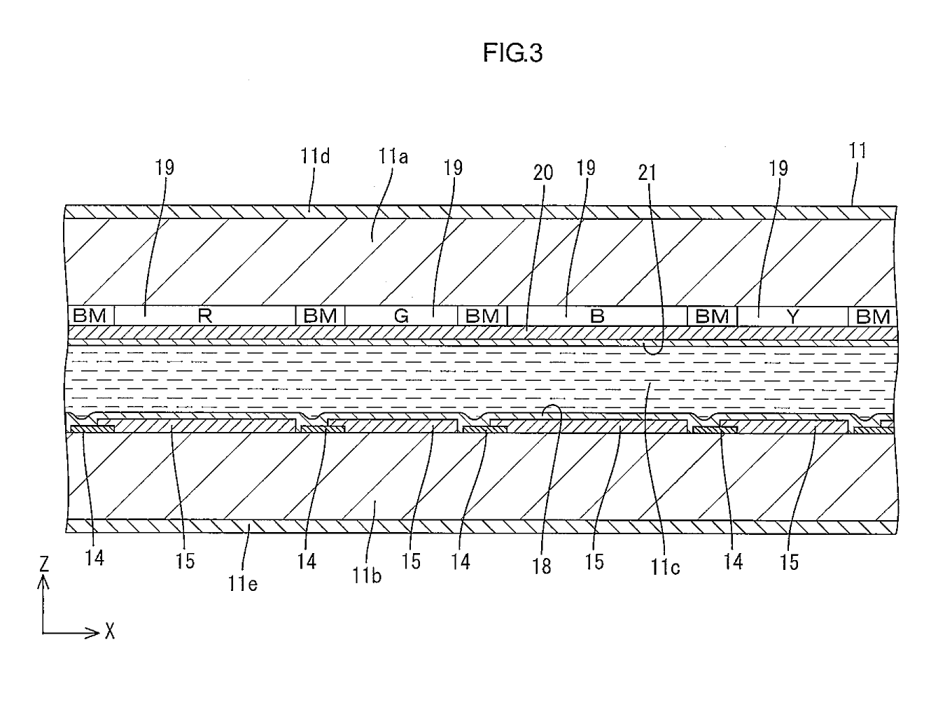

The liquid crystal panel 11 included in the liquid crystal display device 10 will be described. An overall shape of the liquid crystal panel 11 (display panel) is landscape rectangular (a rectangular shape). As illustrated in FIG. 3, the liquid crystal panel 11 includes transparent glass substrates 11a and 11b (have light transmissivity) and a liquid crystal layer 11c. The liquid crystal layer 11c is provided between the substrates 11a and 11b. The liquid crystal layer 11c includes liquid crystals having optical characteristics that vary according to electric fields applied thereto. The substrates 11a and 11b are bonded together with a predetermined gap corresponding to the thickness of the liquid crystal layer therebetween with sealant that is not illustrated. Polarizing plates 11d and 11e are attached to outer surfaces of the substrates 11a and 11b, respectively. The long-side direction and the short-side direction of the liquid crystal panel 11 are aligned with the X-axis direction and the Y-axis direction, respectively.

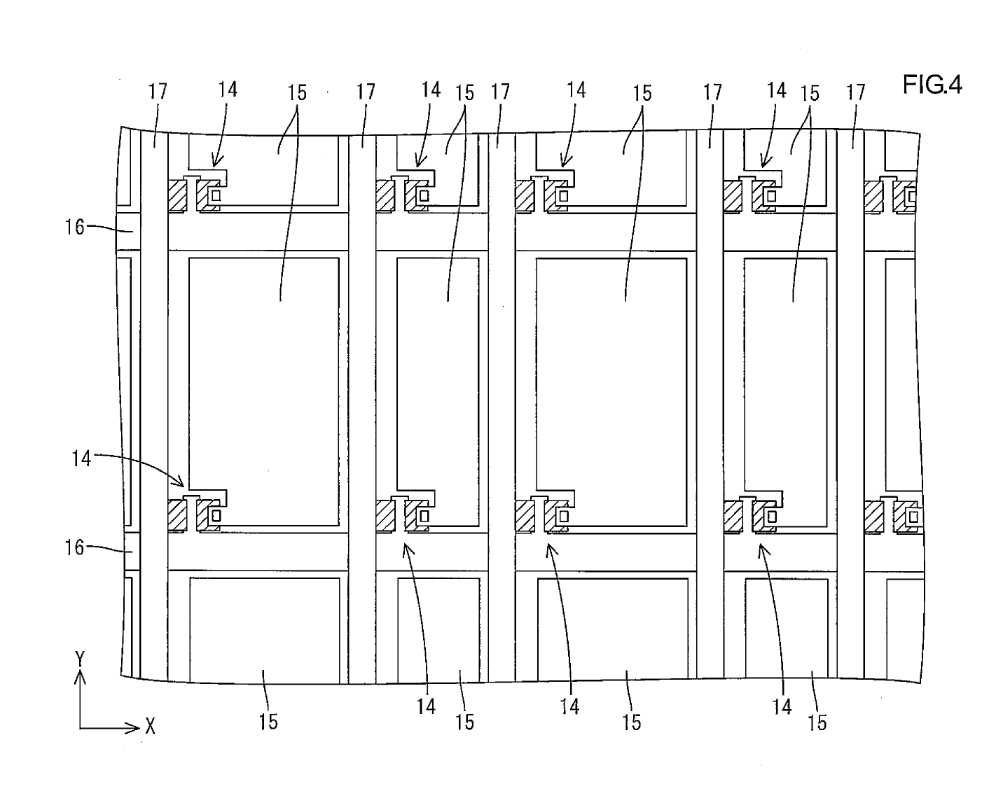

One of the substrates 11a and 11b on the front side is a CF board 11a and the other one of the substrates 11a and 11b on the rear side (on the backside) is an array board 11b. On an inner surface of the array board 11b, that is, a surface on the liquid crystal layer 11c side (opposite to the CF board 11a), a number of thin film transistors (TFTs) 14 and pixel electrodes 15 are arranged in a matrix (in columns and rows) as illustrated in FIG. 4. The TFTs 14 are switching elements. Furthermore, gate lines 16 and source lines 17 are arranged perpendicular to each other and around the TFTs 14 and the pixel electrodes 15. Each pixel electrode 15 has a rectangular shape with the long-side direction and the short-side direction aligned with the Y-axis direction and the X-axis direction, respectively. The pixel electrode 15 is a transparent electrode made of indium tin oxide (ITO) or zinc oxide (ZnO). The gate lines 16 and the source lines 17 are connected to gate electrodes and source electrodes of the respective TFTs 14. The pixel electrodes 15 are connected to drain electrodes of the respective TFTs 14. As illustrated in FIG. 3, an alignment film 18 is arranged on the liquid crystal layer 11c side of the TFTs 14 and the pixel electrodes 15. The alignment film 18 is provided for alignment of liquid crystal molecules. In end portions of the array board 11b, terminals extended from the gate lines 16 and the source lines 17 are provided. A driver component for driving the liquid crystal panel 11 is pressure bonded to the terminals via an anisotropic conductive film (ACF). The driver component is not illustrated in the drawings. The driver component is electrically connected to a display control circuit board via various wiring boards. The display control circuit board is not illustrated in the drawings. The display control circuit board is connected to the image converter circuit board VC (refer to FIG. 1) of the television device TV and configured to feed driving signals to the lines 16 and 17 according to output signals from the image converter board circuit VC via the driver component.

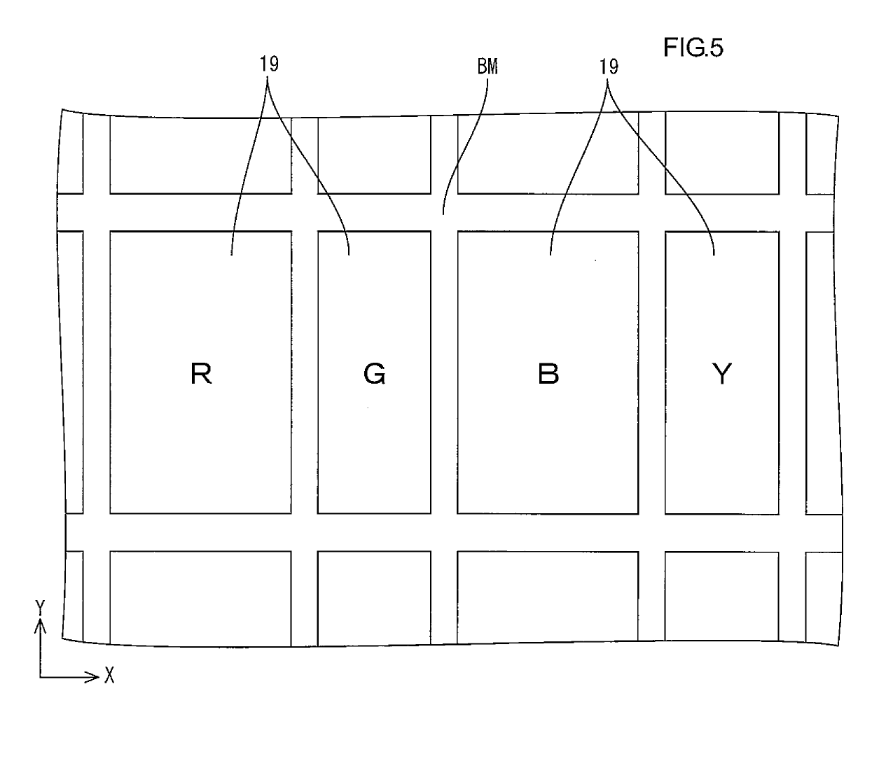

On an inner surface of the CF board 11a, that is, on the liquid crystal layer 11c side (opposite to the array board 11b), color filters 19 including a number of R, G, B, and Y color portions are arranged in a matrix (in columns and rows) according to the pixels on the array board 11b side, as illustrated in FIG. 5. The color filters 19 include the Y color portions in yellow in addition to the R color portions in red, the G color portions in green, and the B color portions in blue. Red, green, and blue are three primary colors of light. The R color potions, the G color portions, the B color portions, and the Y color portions selectively pass the respective colors (or wavelengths) of light. Each of the R, G, B, and Y color portions has a rectangular shape with the long-side direction and the short-side direction thereof aligned with the X-axis direction and the Y-axis direction, respectively. A grid-like light blocking layer (a black matrix) BM is provided between the R color portion, the G color portion, the B color portion, and the Y color portion so that colors are less likely to be mixed. As illustrated in FIG. 3, a counter electrode 20 and an alignment film 20 are overlaid with each other on the liquid crystal layer 11c side of the color filters 19 of the CF board 11a.

Arrangement and size of each of the R, G, B, and Y color portions of the color filters 19 will be described. As illustrated in FIG. 5, the R, G, B, and Y color portions are arranged in rows and columns such that the X-axis direction corresponds to the row direction and the Y-axis direction corresponds to the column direction. Dimensions of the R, G, B, and Y color portions that measure in the column direction (the Y-axis direction) are equal. Dimensions of the R, G, B, and Y color portions that measure in the row direction (the X-axis direction) are different from one another. Specifically, the R color portion in red, the G color portion in green, the Y color portion in yellow, and the B color portion in blue are arranged in this sequence from the left side in FIG. 5 in the row direction. The dimensions of the R color portion in red and the B color portion in blue that measure in the row direction are relatively larger than those of the Y color portion in yellow and the G color portion in green. Namely, the R color portions or the B color portions having the relatively large dimension in the row direction and the Y color portions or the G color potions having the relatively small dimension in the row direction are alternately arranged in the row direction. Accordingly, areas of the R color portions in red and the B color portions in blue are larger than areas of the Y color portions in yellow and the G color portions in green. The areas of the B color portions in blue and the R color portions in red are equal. The areas of the G color portions in green and the Y color portions in yellow are equal. In FIGS. 3 and 5, the area of each of the R color portions in red and the B color portions in blue is 1.6 times larger than the area of each of the Y color portions in yellow and the G color portions in green.

As illustrated in FIG. 4, dimensions of the pixel electrodes 15 on the array board 11b that measure in the row direction (the X-axis direction) are different from column to column according to the configuration of the color filters 19 having the above-described configuration. Areas of the pixel electrodes 15 overlapping the R color portions in red and the B color portions in blue are relatively larger than areas of the pixel electrodes 15 overlapping the Y color portions in yellow and the G color portions in green. The gate lines 16 are arranged at equal intervals and the source lines 17 are arranged at two different intervals corresponding to the dimensions of the pixel electrodes 15 that measure in the row direction.

As described above, the liquid crystal display device 10 of this embodiment includes the liquid crystal panel 11 having the color filters 19. Since the color filters 19 include the color portions in four colors, that is, the R, G, B, and Y color portions, the television device TV includes the designated image converter circuit board VC as illustrated in FIG. 1. The image converter circuit board VC converts television image signals from the tuner T to blue, green, red, and yellow image signals. The generated color image signals are inputted to the display control circuit board. The display control circuit board drives the TFTs 14 corresponding to the respective colors of the pixels of the liquid crystal panel 11 based on the image signals and controls the amounts of light passing through the R color portions, the G color portions, the B color portions, and the Y color portions, respectively.

(Backlight Unit)

The configuration of the backlight unit 12 in the liquid crystal display device 10 will be explained. As illustrated in FIG. 2, the backlight unit 12 includes a chassis 22, an optical member set 23, and a frame 26. The chassis 22 has a box-like shape having an opening on a light exit side (on the liquid crystal panel 11 side). The optical member set 23 is arranged so as to cover the opening of the chassis 22. The frame 26 is arranged along outer edges of the chassis 22. Outer edges of the optical member set 23 are sandwiched and held between the chassis 22 and the frame 26. LEDs 24, LED boards 25, and diffuser lenses 27 are arranged inside the chassis 22. The LEDs 24 are arranged directly below and opposite the optical member 23 (the liquid crystal panel 11) and mounted on the LED boards 25. The diffuser lenses 27 are mounted on the LED boards 25 in locations corresponding to the LEDs 24. Namely, the backlight unit 12 in this embodiment is a direct backlight. Further, holding members 28 (attachment members) and a reflection sheet 29 are arranged inside the chassis 22. The holding members 28 support the LED boards 25 with the chassis 22. The reflection sheet 29 reflects light inside the chassis 22 toward the optical member 23. Next, components of the backlight unit 12 will be explained in detail.

(Chassis)

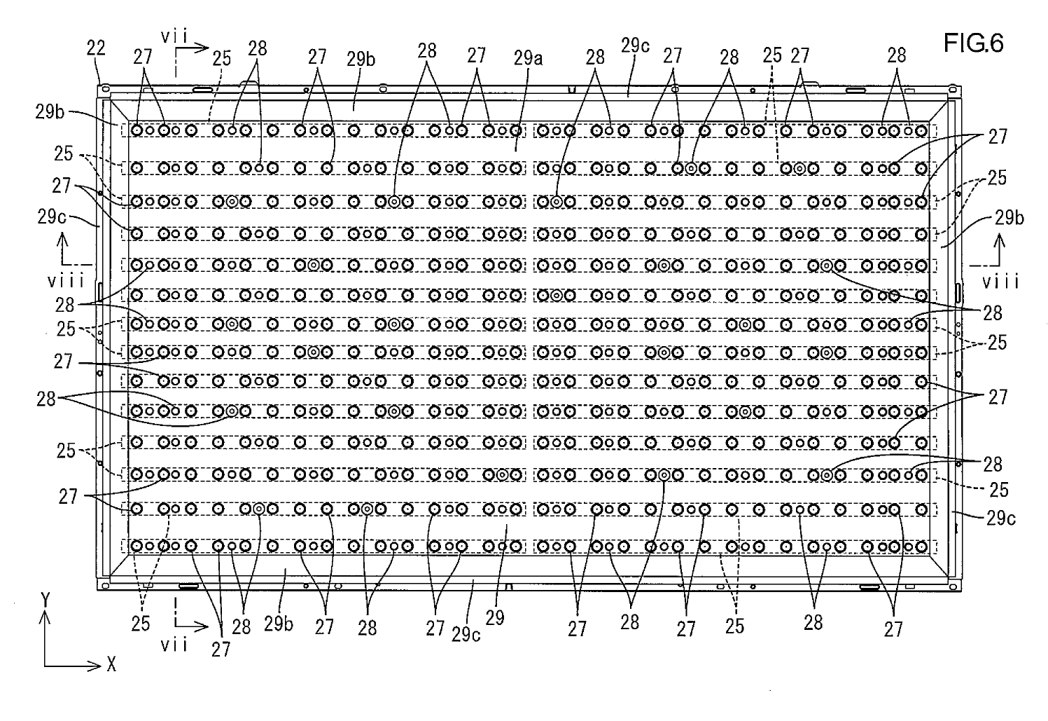

The chassis 22 is made of metal. As illustrated in FIGS. 6 to 8, the chassis 22 has a shallow box-like overall shape (a shallow tray-like overall shape) having an opening on the front side. The chassis 22 includes a bottom plate 22a, side plates 22b, and receiving plates 22c. The bottom plate 22a has a landscape rectangular shape similar to the liquid crystal panel 11. The side plates 22b rise from outer side edges of the bottom plate 22a (a pair of long sides and a pair of short sides) toward the front side (a light exit side). The receiving plates 22c project outward from the distal ends of the respective side plated 22b. The long-side direction and the short-side direction of the chassis 22 are aligned with the X-axis direction (the horizontal direction) and the Y-axis direction (the vertical direction), respectively. The frame 26 and the optical member set 23, which will be explained next, are placed on the receiving plates 22c of the chassis 22. The frame 26 is fixed to the receiving plates 22c with screws. The bottom plate 22a of the chassis 22 has mounting holes 22d for mounting the holding members 28. The mounting holes 22d are distributed at different positions in the bottom plate 22a corresponding to mounting positions of the holding members 28.

(Optical Member)

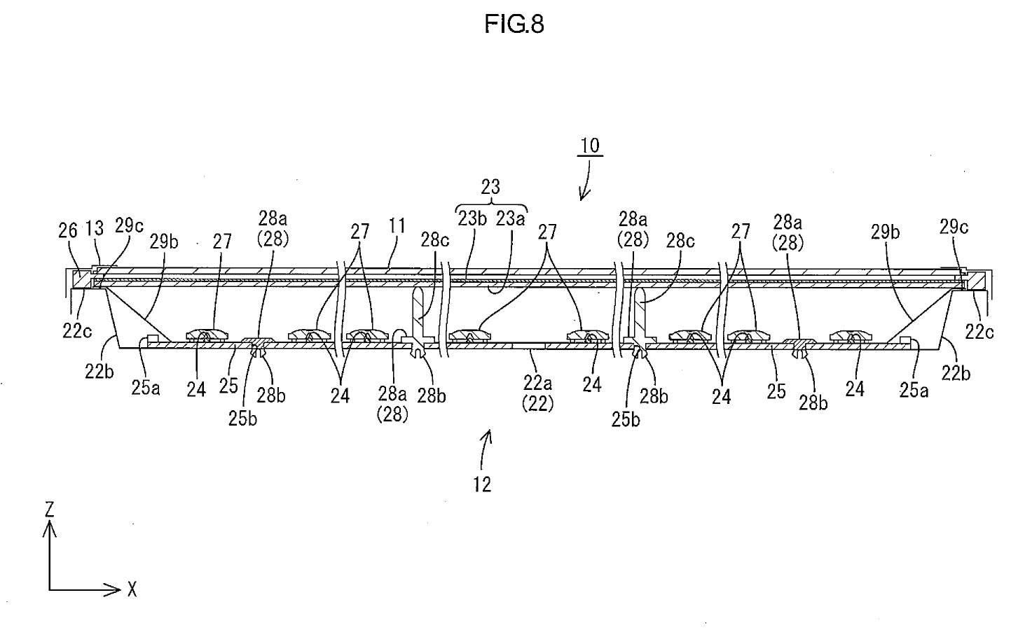

As illustrated in FIG. 2, the optical member set 23 has a landscape rectangular plan-view shape similar to the liquid crystal panel 11 and the chassis 22. As illustrated in FIGS. 7 and 8, outer edges of the optical member set 23 are placed on the respective receiving plates 22c of the chassis 22 so that the optical member set 23 covers the opening of the chassis 22. The optical member set 23 is arranged between the liquid crystal panel 11 and the LEDs 24 (LED boards 25). The optical member set 23 includes a diffuser plate 23a and optical sheets 23b. The diffuser plate 23a is arranged on the rear side (the LEDs 24 side, an opposite side from the light exit side). The optical sheets 23b are arranged on the front side (the liquid crystal panel 11 side, the light exit side). The diffuser plate 23a is a plate-like member having a predetermined thickness. The diffuser plate 23a is made of substantially transparent synthetic resin with light-scattering particles dispersed therein. Each optical sheet 23b has a sheet-like shape having a thickness smaller than that of the diffuser plate 23a. Two optical sheets 23b are overlaid with each other. Examples of the optical sheets 23b are a diffuser sheet, a lens sheet, and a reflection-type polarizing sheet. Each optical sheet 23b can be selected from those sheets accordingly.

(Frame)

As illustrated in FIG. 2, the frame 26 has a frame-like shape extending along peripheries of the liquid crystal panel 11 and the optical member set 23. Outer edges of the optical member set 23 are sandwiched and held between the frame 26 and the receiving plates 22c (refer to FIGS. 7 and 8). The frame 26 receives the outer edges of the liquid crystal panel 11 from the rear side. The bezel 13 is arranged on the front side of the liquid crystal panel 11. The frame 26 and the bezel 13 sandwich and hold the outer edges of the liquid crystal panel 11 therebetween (refer to FIGS. 7 and 8).

(LED)

As illustrated in FIG. 8, each LED 24 is mounted on the LED board 25. A surface of the LED 24 opposite a mounting surface thereof to the LED board 25 is a light emitting surface, that is, the LED 24 is a top light type. The LED 24 includes an LED chip as a light source and a green phosphor and a red phosphor as phosphors. The LED chip emits blue light. The green and the red phosphors emit light when excited by blue light. The LED chip that may be made of an InGaN based material is arranged on a substrate fixed on the LED board 25 and sealed with resin. Each LED chip mounted on the substrate emits light having a dominant wavelength from 420 nm to 500 nm, that is, the dominant wavelength in blue color range. The LED chip emits blue light (blue monochromatic light) with high chromatic purity. A preferable dominant wavelength is 451 nm, for example. The resin sealing the LED chip contains the green phosphor and the red phosphor at specified percentages. The green phosphor emits green light when excited by blue light emitted from the LED chip. The red phosphor emits red light when excited by blue light emitted from the LED chip. With the blue light emitted from the LED chip (a blue component of light), the green light emitted from the green phosphor (a green component of light), and the red light emitted from the red phosphor (a red component of light), the LED 24 emits light in specific color such as white and bluish white. When the green component of light emitted by the green phosphor and the red component of light emitted by the red phosphor are mixed, yellow light is produced. That is, the light emitted by the LED 24 includes the blue component of light emitted by the LED chip and a yellow component of light. The chromaticity of the LED 24 varies according to absolute values or relative values of contents of the green phosphor and the red phosphor. Therefore, the chromaticity of the LED 24 can be adjusted by adjusting the contents of the green phosphor and the red phosphor. In this embodiment, the green phosphor has a main light emitting peak in a green wavelength range from 500 nm to 570 nm, and the red phosphor has a main light emitting peak in a red wavelength range from 600 nm to 780 nm.

The green phosphor and the red phosphor of each LED will be explained in detail. A β-SiAlON, which is a SiAlON-based phosphor, is suitable for the green phosphor. The SiAlON-based phosphor is a nitride in which some silicon atoms of silicon nitride are substituted with aluminum atoms and some nitrogen atoms are substituted with oxygen atoms. The SiAlON-based phosphor as nitride has high emission efficiency and high durability compared to other phosphors consisting of sulfide or oxide, for example. The “high durability” means that, for example, brightness decrease is less likely to occur even if high-energy excitation light emitted from the LED chip exposes the phosphor over time. The SiAlON-based phosphor may use a rare-earth element (such as Tb, Yg, or Ag) as an activator. β-SiAlON is a type of SiAlON-based phosphor and expressed by the general formula Si_{6-z}Al_{z}O_{z}N_{8-z}:Eu (z is the amount of solid solution) or (Si,Al)₆(O,N)₈:Eu, in which aluminum and oxygen are dissolved in a β-type silicon nitride crystal. According to this embodiment, β-SiAlON may use europium (Eu) as an activator. Therefore, the green light as emitted light has particularly high color purity. This high color purity is extremely useful in adjusting the chromaticity of the LEDs 24. For a red color phosphor, CASN, which is a type of CASN-based phosphor, may preferably be used. The CASN-based phosphor is a nitride containing calcium atoms (Ca), aluminum atoms (Al), silicon atoms (Si), and nitrogen atoms (N). The CASN-based phosphor has high emission efficiency and high durability, compared to other phosphors consisting of, for example, sulfide or oxide. The CASN-based phosphor may use a rare-earth element (such as Tb, Yg, or Ag) as an activator. The CASN as a type of CASN-based phosphor uses europium (Eu) as the activator and is expressed by the composition formula CaAlSiN₃:Eu.

(LED Board)

As illustrated in FIG. 6, each LED board 25 includes a substrate having a landscape rectangular shape in a plan view. Each LED board 25 is arranged inside the chassis 22 with the long-side direction and the short-side direction thereof aligned with the X-axis direction and the Y-axis direction, respectively, so as to extend along the bottom plate 22a. The LEDs 24 are surface-mounted on one of board surfaces of each LED board 25 on the front side (facing the optical member set 23). The light emitting surface of each LED 24 is opposed the optical member set 23 (or the liquid crystal panel 11). A light axis of the LED 24 is aligned with the Z-axis direction, that is, a direction perpendicular to the display surface of the liquid crystal panel 11. A plurality of LEDs 24 (i.e. fifteen LEDs 24 in FIG. 6) are arranged in line along the long-side direction of the LED board 25 (the X-axis direction) and connected to a wiring pattern (not illustrated) provided on the LED board 25. Intervals between the LEDs 24 are substantially constant, that is, the LEDs 24 are arranged at substantially equal intervals in the X-axis direction.

As illustrated in FIG. 6, a plurality of the LED boards 25 are arranged in the X-axis direction and a plurality of the LED boards 25 are arranged in the Y-axis direction inside the chassis 22. The long sides and the short sides of the LED boards 25 are aligned, respectively. That is, the LED boards 25 and the LEDs 24 mounted thereon are arranged inside the chassis 22 in rows and columns (in a matrix (or in planer arrangement)) such that the X-axis direction (the long-side directions of the chassis 22 and the LED boards 25) corresponds to the row direction and the Y-axis direction (the short-side directions of the chassis 22 and the LED board 25) corresponds to the column direction. Specifically, two LED boards 25 in the X-axis direction by fourteen LED boards 25 in the Y-axis direction and a total of twenty-eight LED boards 25 are arranged inside the chassis 22. The LED boards 25 are arranged in the Y-axis direction with different intervals corresponding to its location. That is, the LED boards 25 are arranged at unequal intervals in the Y-axis direction. Specifically, the intervals decrease as are closer to the middle area of the chassis 22 (or the liquid crystal display device 10) in the Y-axis direction and the intervals increase as are closer to the end portions of the chassis 22 in the Y-axis direction. Similarly, the LEDs 24 mounted on the LED boards 25 are arranged at unequal intervals in the Y-axis direction. Connectors 25a are provided to one end portion of each LED board 25. The end portion is located closer to the peripheral edges of the chassis 22 than the other end portion in the long-side direction (an opposite end portion from an end portion closer to the adjacent LED board 25 in the X-axis direction). The connector 25a is electrically connected to a connector of an external LED control unit. Each LED 24 mounted on the LED boards 25 is controlled thereby. Further, each LED board 25 has insertion holes 25b corresponding to positions where the holding members 28 are mounted. The insertion holes 25b are holes to which the holding members 28 are inserted.

The substrate of the LED board 25 is made of metal, for instance, aluminum-contained material similar to the chassis 22. On the surface of the substrate, metal film wiring patterns (not illustrated) including copper foil wiring patters are formed via insulating films. A reflection layer (not illustrated) in white having high light reflectivity is formed on the outer most surface of the substrate of each LED board 25. A material used for the substrate of the LED board 25 may be an insulating material including ceramic.

(Diffuser Lens)

Each diffuser lens 27 is made of substantially transparent synthetic resin (has high transmissivity) having a refraction index higher than that of air (e.g., poly carbonate or acrylic). As illustrated in FIGS. 6 and 8, the diffuser lens 27 has a predetermined thickness and has a substantially round plan-view shape. The diffuser lenses 27 are mounted to the LED boards 25 so as to cover the respective LEDs 224 from the front side, namely, the diffuser lenses 27 are arranged so as to overlap the respective LEDs 24 in a plan view. Each diffuser lens 27 diffuses light emitted from the LED 24 and has a strong directivity. Namely, the directivity of the light emitted from the LED 24 is reduced by the diffuser lens 27. Therefore, an area between the adjacent LEDs 24 is less likely to be recognized as a dark spot even if the adjacent LEDs 24 are arranged away from each other. Therefore, the number of the LEDs 24 can be reduced. The diffuser lenses 27 are arranged substantially concentric with the respective LEDs 24. FIG.7 illustrates a cross-sectional configuration of the holding members 28 so that the diffuser lenses 27 illustrated in FIG.7 are behind the holding members in the figure.

(Holding Members)

The holding members 28 will be explained. Each holding member 28 is made of synthetic resin, for instance, polycarbonate. The surface of the holding member 28 is in white having high reflectivity. As illustrated in FIGS. 6 to 8, each holding member 28 includes a main body 28a and a fixing portion 28b. The main body 28a extends along the board surface of the LED board 25. The fixing portion 28b projects from the main body 28a toward the rear side, that is, toward the chassis 22. The fixing portion 28b is fixed to the chassis 22. The main body 28a has a substantially round plate-like shape in a plan view. At least the LED board 25 is sandwiched between the bottom plate 22a of the chassis 22 and the main body 28a. The fixing portion 28b passes through the insertion hole 25d and the mounting hole 22d provided in the LED board 25 and the chassis 22, respectively at a location corresponding to the mounting portion of the holding member 28, and locked at the bottom plate 22a. As illustrated in FIG. 6, a plurality of the holding members 28 are dispersed over the surface of the LED board 25. The holding members 28 are arranged between the adjacent diffuser lenses 27 (or LEDs 24).

The holding members 28 includes two types of holding members as illustrated in FIGS. 6 and 8. One type of the holding members 28 (a first attachment member 31) sandwiches the LED board 25 between the main body 28a and the bottom plate 22a of the chassis 22 without sandwiching a bottom portion 29a of the reflection sheet 29. The other type of the holding members 28 (a second attachment member 32) sandwiches the LED board 25 and the bottom portion 29a of the reflection sheet 29 between the main body 28a and the bottom plate 22a of the chassis 22. The holding members 28 (the second attachment member 32), which sandwich the LED board 25 and the bottom portion 29a of the reflection sheet 29, include the holding member 28 having a support portion 28c and the holding member 28 without the support potion 28c. The support portion 28c projects from the main body 28a toward the front side. The support portion 28c supports the optical member set 23 (specifically, the diffuser plate 23a) from the rear side. With this configuration, a positional relationship between the LEDs 24 and the optical member set 23 with respect to the Z-axis direction remains constant. Furthermore, the optical member set 23 is less likely to accidentally deform.

(Reflection Sheet)

The reflection sheet 29 is made of synthetic resin. The surface of the reflection sheet 29 is in white having high reflectivity. As illustrated in FIGS. 6 to 8, the reflection sheet 29 has a size that covers a substantially entire inner surface of the chassis 22. Therefore, the reflection sheet 29 can cover the LED boards 25 that are arranged in lines inside the chassis 22 at once. The reflection sheet 29 efficiently reflects rays of light inside the chassis 22 toward the optical member set 23. The reflection sheet 29 includes the bottom portion 29a, four rising portions 29b, and extended portions 29c. The bottom portion 29a extends along the bottom plate 22a of the chassis 22 and covers substantially the entire area of the bottom plate 22a. Each rising portion 29b rises from an outer edge of the bottom portion 29a toward the front side at an angle to the bottom portion 29a. Each extended portion 29c extends outwardly from an outer edge of each rising portion 29b so as to be placed on a receiving plate 22c of the chassis 22. The bottom portion 29a of the reflection sheet 29 is arranged on a front surface of the LED board 25, that is, the mounting surface of the LED 24. The bottom portion 29a of the reflection sheet 29 has lens through holes at positions corresponding to the diffuser lenses 27 (LEDs 24) in a plan view. The diffuser lenses 27 are passed through the corresponding lens through holes.

Further, holding member insertion holes are provided to the bottom portion 29a at positions corresponding to the holding members 28 in a plan view. The fixing portions 28b are passed through the respective holding member through holes. Each holding member insertion hole corresponding to the holding member 28 (the first attachment member 31) that holds the LED board 25 without involving the bottom portion 29 of the reflection sheet is larger than the main body 28a of the holding member 28. Therefore, the main body 28a can pass through the holding member insertion hole. With this configuration, the LED boards 25 arranged in the chassis 22 can be fixed to the bottom plate 22a of the chassis 22 by the above holding members 28 (the first attachment member 31) before the reflection sheet 29 is arranged inside the chassis 22. If the reflection sheet 29 is arranged after that, the bottom portion 29a is less likely to overlap the main body 28a of the holding member 28 (the first attachment member 31). Further, since the bottom portion 29a is fixed to the chassis 22 together with the LED boards 25 by the holding members 28 (the second attachment member 32) after being arranged inside the chassis 22, the bottom portion 29a is less likely to lift or deform.

(Purpose of Four Primary Color Liquid Crystal Panel and Different Area-Ratio of the Color Filters)

As described above, the color filters 19 of this embodiment include the Y color portions in addition to the R color portions, the G color portions, and the B color portions in three primary colors of light, as illustrated in FIGS. 3 and 5. Therefore, a color range of the display images displayed with the transmitted light is expanded and the images can be displayed with high color reproducibility. The light passed through the Y color portion in yellow has a wavelength close to a visible peak. Therefore, people perceive the light as bright light even if the light is emitted with low energy. Namely, even if the outputs of the LEDs 24 in the backlight unit 12 are reduced, sufficient brightness still can be achieved. Accordingly, the power consumption of the LEDs 24 can be reduced and the backlight unit 12 is provided with high environmental efficiency.

If the four-primary-color-type liquid crystal panel 11 described above is used, an overall color of the display images tends to be yellowish. In the backlight unit 12 of this embodiment, the chromaticity of the display images is corrected by adjusting the chromaticity of the LEDs 24 to bluish, which is a complementary color of yellow. Accordingly, the LEDs 24 in the backlight unit 12, as described above, emitted light the dominant wavelength of which is in blue color range and a component of which being in the blue color range has the highest light intensity.

As described above, in the adjustment of the chromaticity of the LEDs 24, the inventor found that brightness of emitted light decreases as the chromaticity of light changes from white to blue. Therefore, in the color filters 19 in this embodiment, the area ratio of the B color portion in blue is relatively larger than those of the G color portion in green and the Y color portion in yellow. With this configuration, the transmitted light through the color filters 19 tends to have a large amount of blue light, which is a complementary color of yellow. As a result, the chromaticity of the LEDs 24 need not be significantly shifted toward blue to correct the chromaticity of the display images. Therefore, the decrease in brightness of the LEDs 24 as a result of chromaticity adjustment is less likely to occur.

According to further study of the inventor, if the four-primary-color-type liquid crystal panel 11 is used, brightness of red components of emitted light decreases particularly among the components of the light emitted from the liquid crystal panel 11. In the four-primary-color-type liquid crystal panel 11, compared to the three-primary-color-type liquid crystal panel 11, the number of sub-pixels constituting each pixel is increased from three to four. Thus, the area of each sub-pixel decreases and this may cause a decrease in the color brightness of red light in particular. In the color filter 19 in this embodiment, the area ratio of the R color portion in red is relatively larger than those of the G color portion in green and the Y color portion in yellow. With this configuration, the transmitted light through the color filters 19 tends to have a large amount of red light. Thus, the decrease in brightness of the red light as a result of the adoption of the four-primary-color type is less likely to occur.

(Explanation for Main Components of this Embodiment)

The configuration and arrangement of the holding members 28 will be explained in detail. The attachment procedures of the holding members 28 to the chassis 22 will be also explained. The main body 28a of the first attachment member 31 is a first head portion 31a and the main body 28a of the second attachment member 32 is a second head portion 32a. The fixing member 28b of the first attachment member 31 is a first axial portion 31b and the fixing member 28b of the second attachment member 32 is a second axial portion 32b. The second attachment member 32 having the support portion 28c is defined as a second attachment member having a support portion 33 to distinguish it from the attachment members 32 without the support portion 33. In the insertion holes 25b of the LED board 25 for the holding members 28, the insertion hole 25b for the first attachment member 31 is a first board insertion hole 25c and the insertion hole 25 for the second attachment member 32 is a second board insertion hole 25d. In the holding member insertion holes formed in the reflection sheet 29 for the holding members 28, the holding member insertion hole for the first attachment member 31 is a first reflection sheet insertion hole 29d and the holding member insertion hole for the second attachment member 32 is a second reflection sheet insertion hole 29e. Each of the above-mentioned parts corresponds to each part having the same name described in claims.

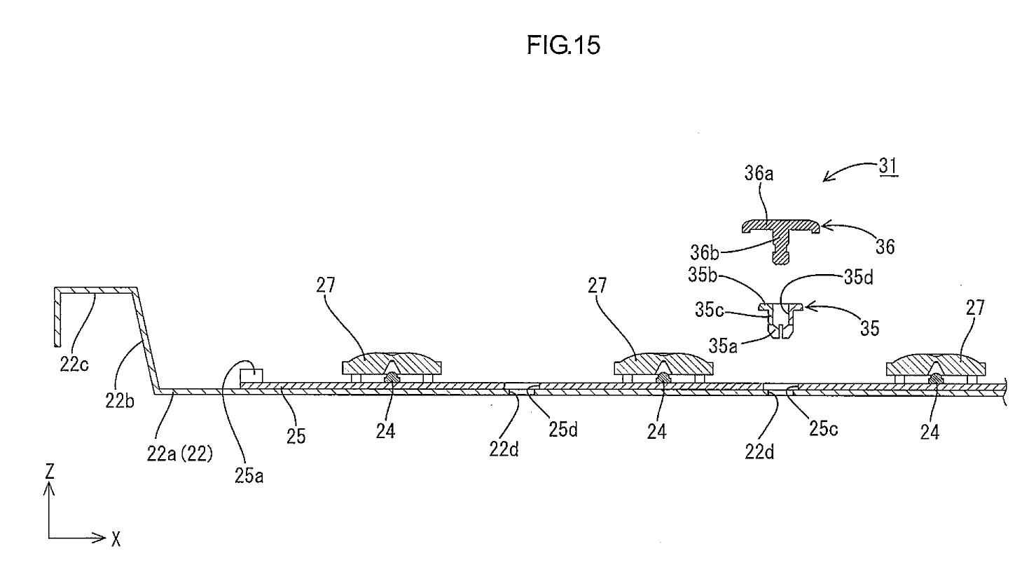

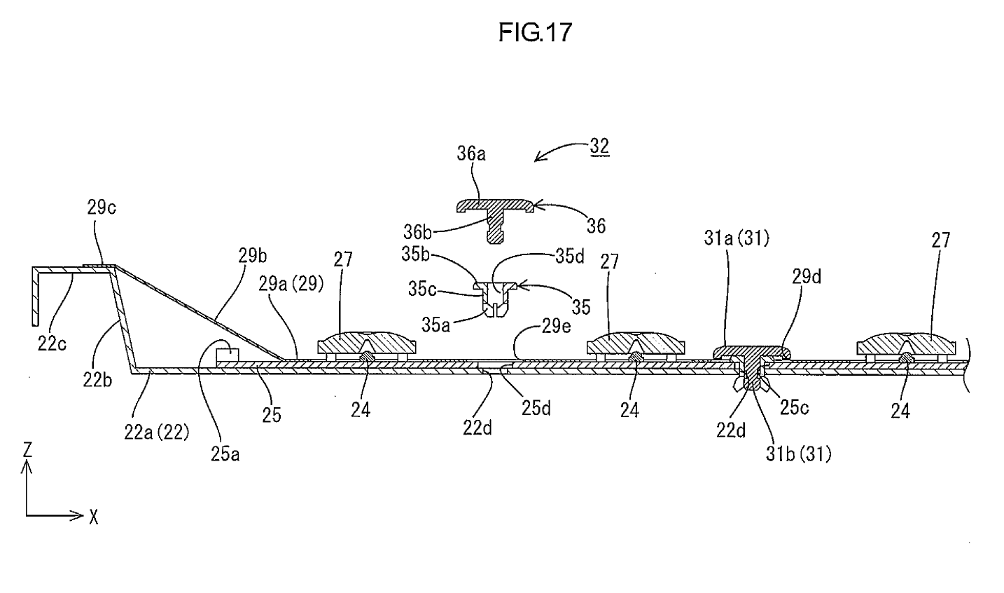

As illustrated in FIGS. 15 and 17, each of the first and the second attachment members 31 and 32 include two pieces. One is a first piece 35 and the other is a second piece 36. The first piece 35 has four elastic stopper portions 35a that are held against the rear side of the chassis 22. The second piece 36 is attached to the first piece 35 from the front side so as to be detachable.

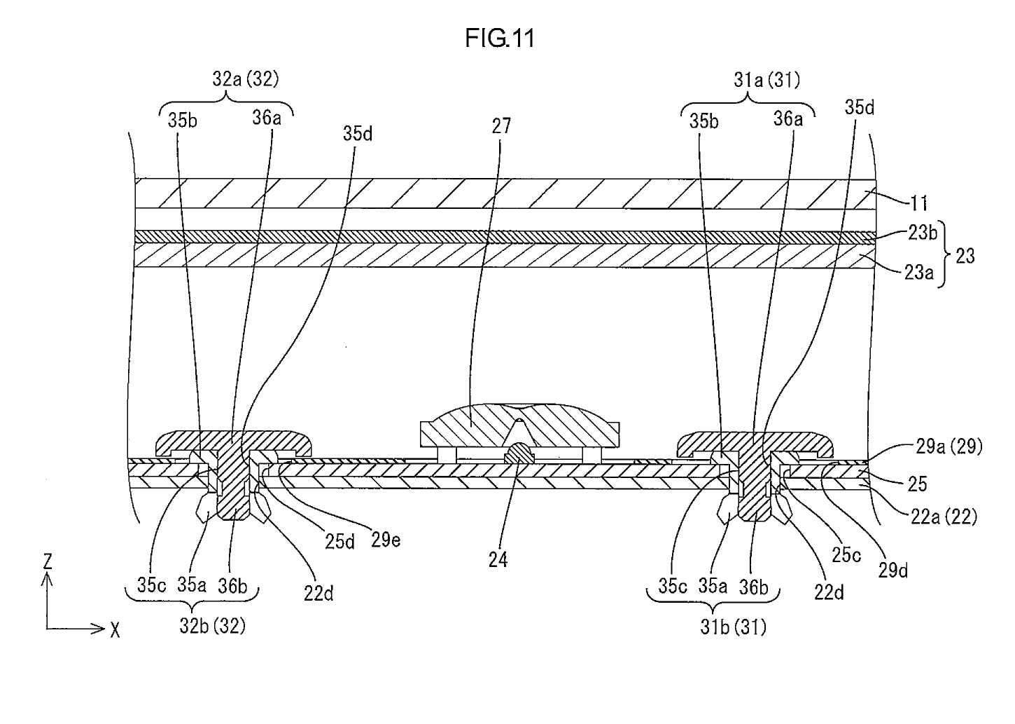

As illustrated in FIG. 11, the first piece 35 has a board head portion 35b at an opposite end (the front side) from the four elastic stopper portions 35a. The board head portion 35b of the first piece 35 extends outwardly and has an outer diameter larger than diameters of the first and the second board insertion holes 25c and 25d. The board head portions 35 press hole edges of the first and the second board insertion holes 25c and 25d, respectively, from the front side. A portion of the first piece 35 between the board head portion 35b and the elastic stopper portions 35a is a base portion 35c. The base portion 35c has a cylindrical shape and has an outer diameter slightly smaller than a diameter of the mounting hole 22d of the chassis 22 and diameters of the first and the second board insertion holes 25c and 25d. The base portion 35c has an opening portion 35d. The opening portion 35d is open to the front side such that the second piece 26 can be inserted thereto. The opening portion 35 is also open to the rear side via slits that are formed between the elastic stopper portions 35a. Inner surfaces of the elastic stopper portions 35a are inclined surfaces that are inclined at an angle to the opening portion 35d.

As illustrated in FIG. 11, the second piece 36 has a substantially T-shaped cross section. A portion of the second piece 36 having the T-shaped cross section is a reflection sheet head portion 36a. Another portion of the second piece 36 projecting from the reflection sheet head portion 36a to the rear side is an axial portion 36b. The reflection sheet head portion 36a has a substantially round plan view shape with a diameter larger than an outer diameter of the board head portion 35b. The reflection sheet head portion 36a has a diameter smaller than that of the first reflection sheet insertion hole 29d and thus can pass through the first reflection sheet insertion hole 29d. On the other hand, the diameter of the reflection sheet head portion 36a is larger than that of the second reflection sheet insertion hole 29e. Therefore, if the reflection sheet head portion 36a is arranged to the second reflection sheet insertion hole 29e, the reflection sheet head portion 36a entirely covers the second reflection sheet insertion hole 29e. An outer peripheral portion of the reflection sheet head portion 36a is located upward and close to a hole edge of the second reflection sheet insertion hole 29e. Thus, the hole edge of the second reflection sheet insertion hole 29e is less likely to lift. Since the outer peripheral portion of the reflection sheet head portion 36a is arranged so as not to be in contact with the hole edge of the second reflection sheet insertion hole 29e, warping is less likely to occur even if the reflection sheet 29 is deformed by thermal expansion. The axial portion 36b has a projecting length substantially the same as a length of the first piece 35 in the Z-axis direction. The axial portion 36b has a diameter that is slightly smaller than a diameter of the opening portion 35d of the first piece 35. Therefore, the axial portion 36b can be inserted into and removed from the opening portion 35d. The second piece (not illustrated) included in the second attachment member having the support portion 33 further includes the support portion 28c, which differs from the above-mentioned second piece 36. The support portion 28c projects from the reflection sheet head portion 36a. Since other configurations are the same as the above mentioned second piece 36, the configurations thereof will not be explained in detail.

If the axial portion 36b of the second piece 36 is inserted to the opening portion 35d of the above first piece 35. As a result, the board head portion 35b of the first piece 35 and the reflection sheet head portion 36a of the second piece 36 overlap each other, and this configures each of the first and the second head portions 31a and 32a. The axial portion 36b of the second piece 36 is arranged so as to fill hollow portions between the base portion 35c of the first piece 35 and the four elastic stopper portions 35a, and this configures each of the first and the second axial portion 31b and 32b. By providing the first reflection sheet insertion hole 29d, which has the larger diameter than the second reflection sheet insertion hole 29e, to the reflection sheet 29, the first and the second attachment members 31 and 32 (except the second attachment member having the support portion 33) can have different functions even though the first and the second attachment members 31 and 32 have the same configuration, namely, each include the first piece 35 and the second piece 36.

Next, the arrangement of the first and the second attachment members 31 and 32 will be explained.

As illustrated in FIG. 6, five or seven holding members 28 (the first and the second attachment members 31 and 32) are arranged on each LED board 25. One or none of holding members 28 is arranged between adjacent LEDs 24. Diffuser lenses 27 are arranged on the LED boards 25 so as to cover the respective LED 24 from the front side. Therefore, the LEDs 24 and the respective diffuser lenses 27 overlap each other in a plan view.

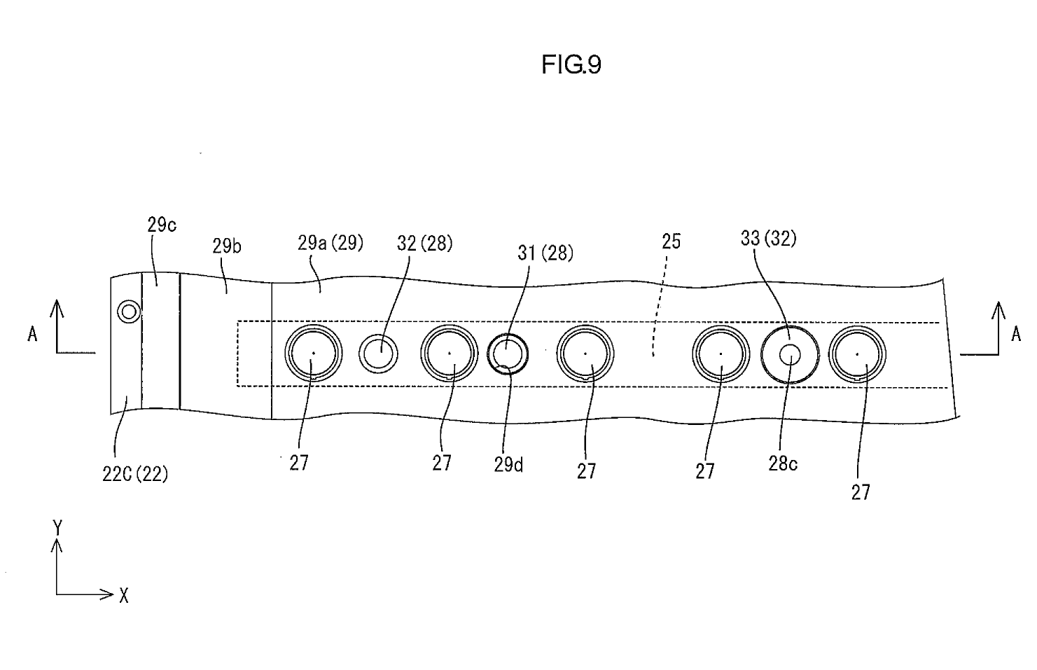

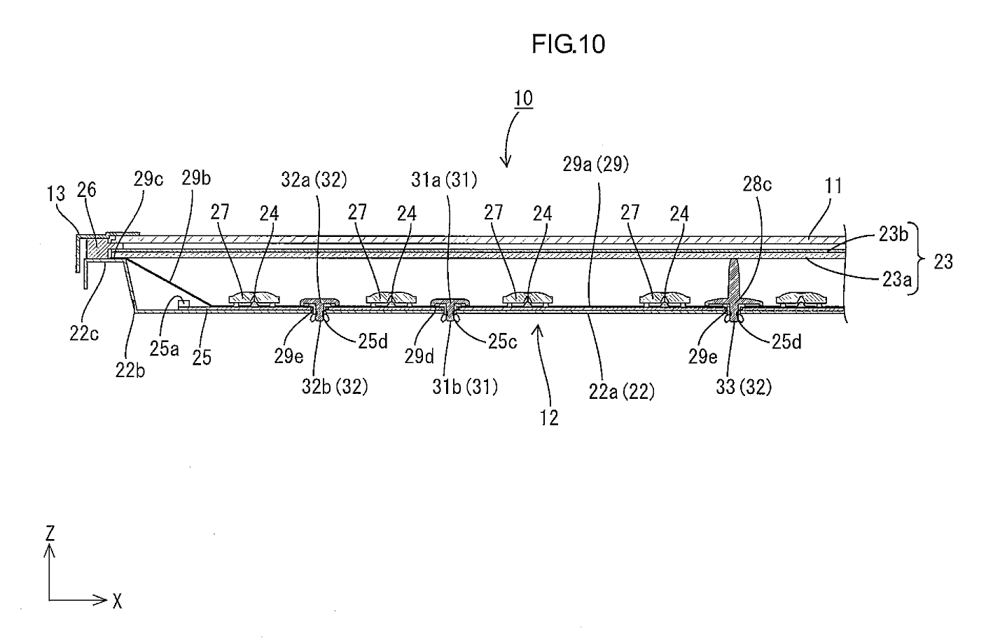

The first attachment members 31 and the second attachment members 32 are arranged on specific LED boards 25 such that the second attachment member 32 is located closer to the end portions of the LED board 25 than the first attachment member 31. Specifically, one LED 24, the second attachment member 32, another LED 24, the first attachment member 31, and another LED 24 are arranged in this sequence from the left side of each LED board 25 illustrated in FIGS. 9 and 10. FIG. 9 illustrates a magnified view of the LED board 25 in the left column and the third row from the top in FIG. 6. FIG. 10 is a cross-sectional view taken along line A-A in FIG. 9.

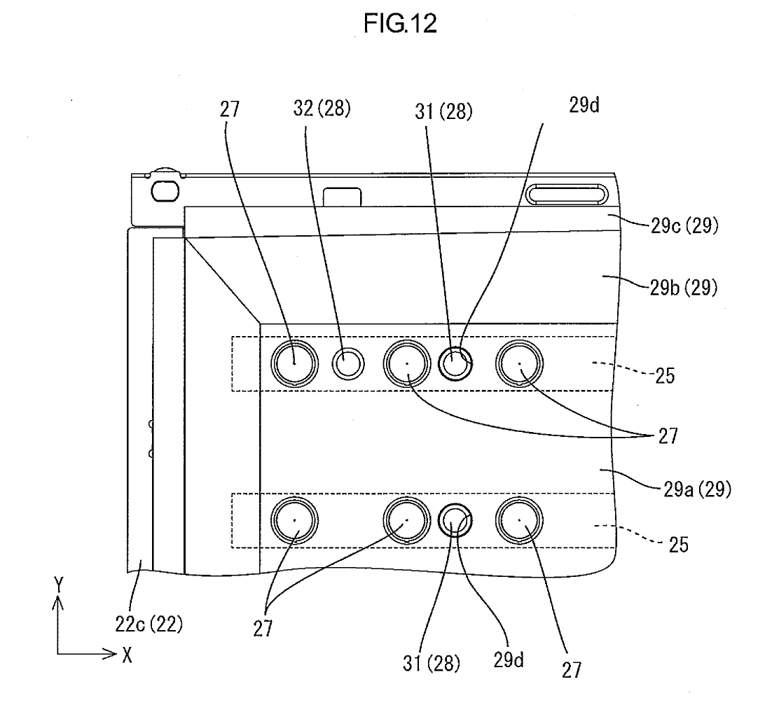

As illustrated in FIG. 12, on the LED board 25 arranged at the upper left corner of the chassis 22, the second attachment member 32 is arranged closer to the left end portion of the LED board 25 than the first attachment member 31. That is, the second attachment member 32 is arranged closer to a corner portion of the chassis 22 than the first attachment member 31. Specifically, one LED 24, the second attachment member 32, another LED 24, and the first attachment member 31 are arranged in this sequence from the left end portion of the LED board 25 located in the left column and the first row (the top left) among the LED boards 25 arranged in the matrix. FIG. 12 illustrates the top left corner portion of the chassis 22 of FIG. 6 among the corner portions of the chassis 22. However, the LED boards 25 arranged at four corners have the second attachment members 32 that are arranged closer to the end portions of the respective LED boards 25 (four corners of the chassis 22) than the first attachment members 31.

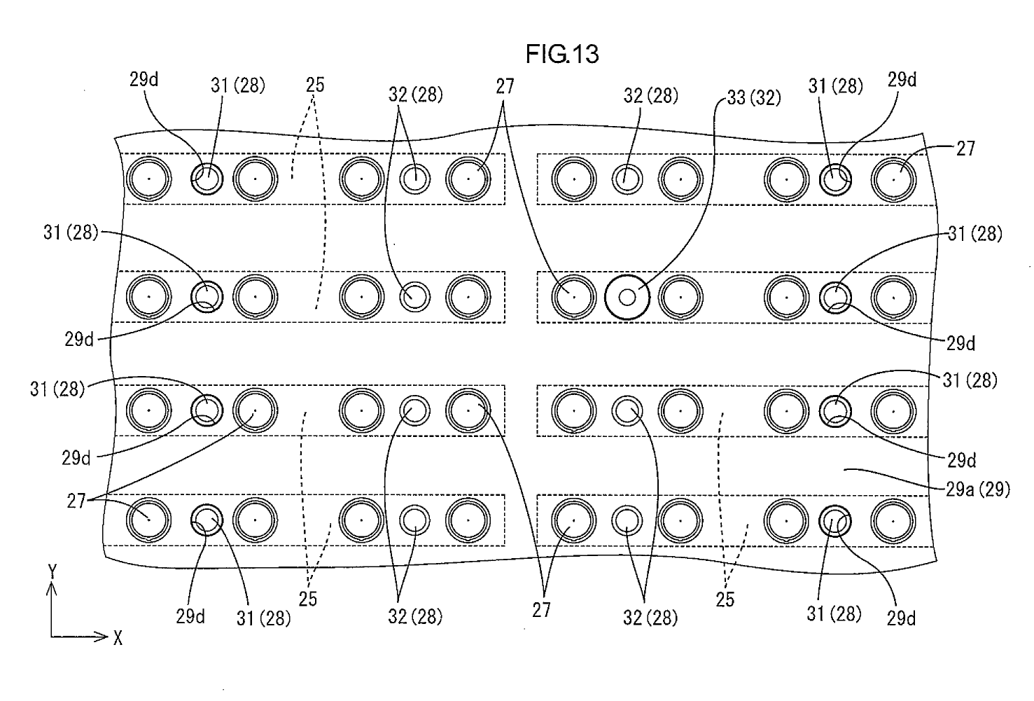

As illustrated in FIG. 13, at the end portion of the LED board 25 opposite the end portion of the adjacent LED board 25 in the X-axis direction, the second attachment member 32 is arranged closer to the end portion than the first attachment members 31. Specifically, on each LED board 25 in the left column, one LED 24, the second attachment member 32, another LED 24, another LED 24, and the first attachment member 31 are arranged in this sequence from the right end portion. On each LED board 25 in the right column, one LED 24, the second attachment member 32 (including the attachment member having the support portion 33), another LED 24, another LED 24, and the first attachment member 31 are arranged in this sequence from the left end portion. FIG. 13 illustrates the middle area of the chassis 22 in FIG. 6. However, every pair of the LED boards 25 arranged in the X-axis direction has the same configuration.

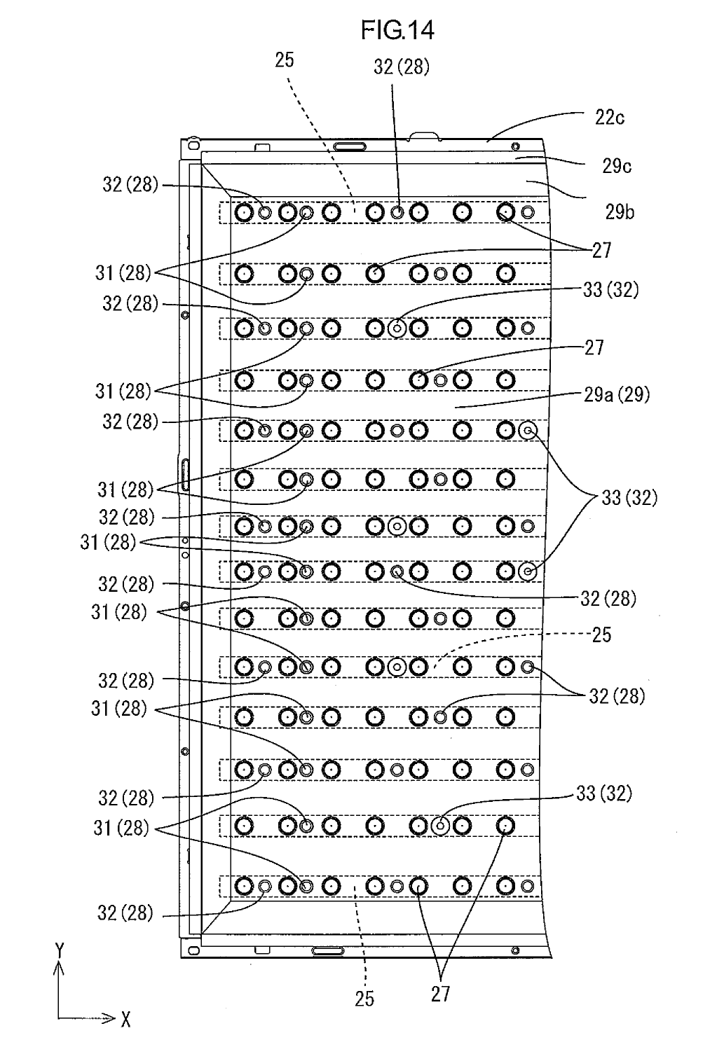

As illustrated in FIG. 14, the first attachment members 31 are arranged in line on each LED board 25 along an arranging direction of the LED boards 25 (the Y-axis direction). Specifically, the LEDs 24 are arranged in the matrix on the fourteen LED boards 25 in the left column in FIG. 6. One of the first attachment members 31 is arranged between the second and the third LEDs 24 from the left end portion of each LED board 25 in the left column. Another first attachment member 31 is arranged between the third and the fourth LEDs 24 from the right end portion of each LED board 25 in the left column. Further, the LEDs 24 are arranged in the matrix on the fourteen LED boards 25 in the right row in FIG. 6. One of the first attachment members 31 is arranged between the second and the third LEDs 24 from the right end portion of each LED board 25 in the right row. Another first attachment member 31 is arranged between the third and the fourth LEDs 24 from the left end portion of each LED board 25 in the right row.

Two first attachment members 31 are arranged on each LED board 25. Specifically, only two first attachment members 31 are arranged at the above-mentioned positions of each LED board 25.

Next, the attachment procedures of the first and second attachment members 31 and 32 will be explained.

First, as illustrated in FIG. 15, the LED board 25 is arranged on the chassis 22 so as to match positions of the mounting hole 22d of the chassis 22, the first board insertion hole 25c, and the second board insertion hole 25d.

Next, the first attachment member 32 is attached to the chassis 22. Specifically, the first piece 35 is inserted to the first board insertion hole 25c from the front side. The elastic stopper portions 35a is passed through the mounting hole 22d of the chassis 22. The board head portion 35b comes in contact with the hole edge of the first board insertion hole 25c. The shape of elastic stopper portions 35a of the first piece 35 is not elastically changed outwardly (in a closed state) by this insertion. Then, the axial portion 36b of the second piece 36 is inserted to the opening portion 35d of the first piece 35. An end portion of the axial portion 36b of the second piece 36 comes in contact to the inclined surfaces of the elastic stopper portion 35a of the first piece 35. The shape of the elastic stopper portions 35a elastically changes outwardly. The second piece 36 is inserted until the reflection sheet head portion 36a comes in contact with the board head portion 35b of the first piece 35. The chassis 22 and the LED board 25 are sandwiched between the elastic stopper portions 35a and the board head portion 35b. The attachment of the LED board 25 to the chassis 22 by the first attachment member 31 is complete.

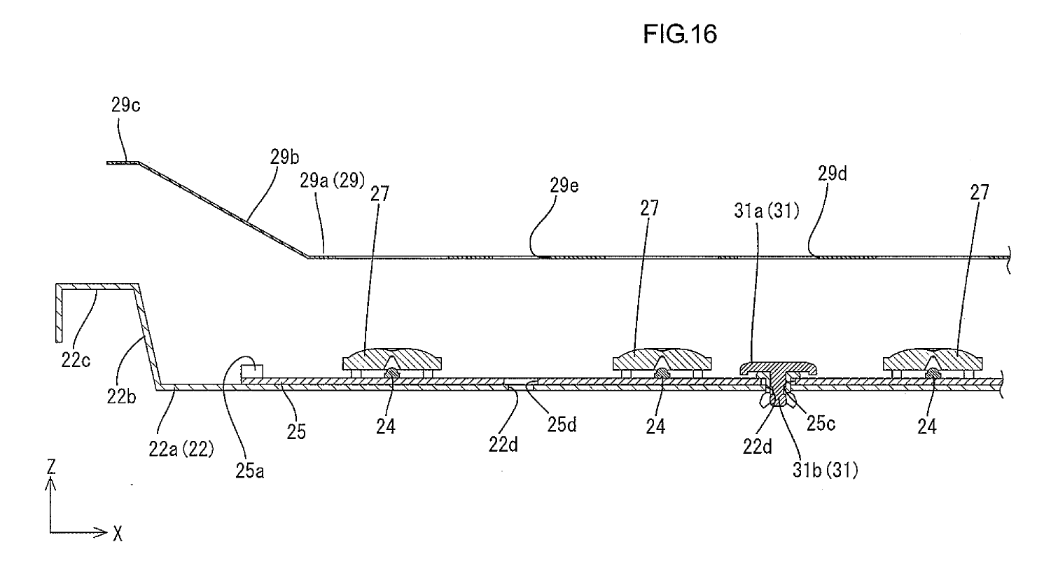

Next, as illustrated in FIG. 16, the reflection sheet 29 is arranged on the front surface of the LED boards 25 so as to match the positions of the first board insertion holes 25c and the first reflection sheet insertion holes 29d. The first head portions 31a of the first attachment members 31 are passed through the respective first reflection sheet insertion holes 29d of the reflection sheet 29.

Next, as illustrated in FIG. 17, the second attachment member 32 is attached to the chassis 22. Specifically, the first piece 35 is inserted to the second board insertion hole 25d and the second reflection sheet insertion hole 29e from the front side. Then, the second piece 36 is attached to the first piece 35 following the same procedures of attaching the first attachment member 31 described above. As a result, the chassis 22 and the LED board 25 are sandwiched between the elastic stopper portions 35a and the board head portion 35b, while the reflection sheet head portion 36a is located upward and close to the hole edge of the second reflection sheet insertion hole 29e. The attachment of reflection sheet 29 and the LED board 25 to the chassis 22 by the second attachment member 32 is complete.

By attaching the first attachment members 31, the reflection sheet, and the second attachment members 32 to the chassis 22 in this sequence, attachment of the LED board 25 and the reflection sheet 29 to the chassis 22 is complete.

(Explanation for Operations and Effects of the Main Components of this Embodiment)

In this embodiment, the second attachment members 32 are arranged closer to the end portions of the LED board 25 than the first attachment members 31 as illustrated in FIG. 10. Therefore, uneven brightness that may be caused by the first attachment members 31 is more likely to be suppressed. In general, if the reflection sheet 29 is fluctuated, the reflection sheet 29 reflects light to different directions and this may cause uneven brightness in the backlight unit 12. Edge portions of the reflection sheet 29 are more likely to lift from the chassis 22 and this may be a factor of fluctuation. In this embodiment, the second attachment members 32 are located at the end portions of the LED boards 25. The second attachment members 32 fix not only the LED boards 25 but also the reflection sheet 29 to the chassis 22. Therefore, at least apart of each LED board 25 that is located at the edge portion of the chassis 22 is attached to the chassis 22 with the second attachment member 32. Namely, the reflection sheet 29 is also attached to the chassis 22 at parts corresponding to the edge portions of the chassis 22 with the second attachment members 32. Thus, the reflection sheet 29 is less likely to lift from the edge portions of the chassis 22. On the other hand, the first attachment member 31 does not have a function to attach the reflection sheet 29 to the chassis 22. If the first attachment member 31 is attached to the end portions of the LED board 25, a part of the reflection sheet 29 that is located at the edge portion of the chassis 22 may lift from the chassis 22 and this may cause uneven brightness.

According to this embodiment, as illustrated in FIG. 13, the second attachment members 32 are attached to the end portions of the LED boards 25, that is, the first reflection sheet insertion holes 29d are not arranged close to each other at end portions of the adjacent LED boards 25. Accordingly, dark spots that may be caused by the first reflection insertion holes 29d are less likely to be visible. If the first attachment members 31 are arranged at the end portions of the adjacent LED boards 25, the first attachment members 31 are located close to each other and dark spots caused by the first attachment members 31 may be easily visible. Specifically, the head portion 31a of the first attachment member 31 is passed through the first reflection sheet insertion hole 29d. Therefore, the surface of the LED board 25, which has lower light reflectivity than the reflection sheet 29, is exposed from the first reflection sheet insertion hole 29d. If the first attachment members 31 are arranged close to each other, the exposed parts of the surface of the LED boards 25 are located close to each other and dark spots may be easily visible. On the other hand, the second attachment member 32 has the second head portion 32a of which diameter is larger than that of the second reflection sheet insertion hole 29e. Therefore, the second head portion 32a can cover the second reflection sheet insertion hole 29e. Thus, areas around the second attachment members 32 are less likely visible as dark spots.

According to this embodiment, as illustrated in FIG. 12, the first attachment members 31 is arranged closer to the end portion of the LED board 25 arranged at the corner portion of the chassis 22 than the second attachment member 32. Thus, the uneven brightness caused by the uplift of the reflection sheet 29 is more likely to be suppressed. Namely, since the second attachment member 32 fixes the LED board 25 and the reflection sheet 29 to the corner portion of the chassis 22, the uplift of the reflection sheet 29 is suppressed or less likely to occur at the corner portion of the chassis 22.

Further, according to this embodiment, the second attachment members 32 are arranged closer to the end portions of four LED boards 25 arranged at the four corners of the rectangular chassis 22 than the first attachment members 31. Therefore, the uplift of the reflection sheet 29 is suppressed or less likely to occur at the four corners of the chassis 22. Consequently, the uneven brightness that may be caused by the uplift of the reflection sheet 29 is less likely to occur.

According to this embodiment, as illustrated in FIG. 13, the second attachment member 32 is arranged at the end portion of the LED board 25 opposite the end portion of the adjacent LED board 25 along an arranging direction of the LEDs 24 (the X-axis direction). Therefore, uneven brightness that may be caused by the first reflection sheet insertion holes 29d arranged close to each other is less likely to occur. Namely, at the opposite end portions of the two adjacent LED boards, at least two second attachment members 32 are arranged between the two first attachment members 31 that are respectively arranged on the respective adjacent LED boards 25. Thus, the first attachment members 31 can be arranged away from each other.

According to this embodiment, the second attachment members 32 are arranged at the end portions of all of the LED boards 25 that are located on the middle area of the chassis 22. Therefore, the first attachment members 32 are less likely to be arranged close to each other in the X-axis direction. Accordingly, the first reflection sheet insertion holes 29d that may cause dark spots are less likely to be arranged close to each other. Thus, uneven brightness, which may be cause by the first reflection sheet insertion holes 29d arranged close to each other, is less likely to occur.

As illustrated in FIG. 14, the first attachment members 31 are arranged in line along the arranging direction of the LED boards 25 (the Y-direction). Therefore, attaching work for the first attachment members 31 is easily performed. In particular, if the attaching work for the first attachment members 31 is performed along the board arranging direction, the previously attached first attachment member 31 and the subsequently attaching first attachment member 31 are located adjacent to each other along the arranging direction of the LED boards 25. Thus, the attachment work of the first attachment members 31 can be easily performed. In addition, if a jig for attaching a plurality of the first members 31 at once is used, the jig can have a linear configuration. Further, the jig can be used from a direction perpendicular to the direction in which the first attachment members 31 are linearly aligned.

The first and second attachment members 31 and 32 have the same configuration, namely, each include the second piece 36. The first and second attachment members 31 and 32 except for the second attachment member having the support portion 33 have the same configuration, namely, each include the first piece 35. Therefore, the same first and second pieces 35 and 36 can be used for the first and second attachment members 31 and 32 only by providing the first and second reflection sheet insertion holes 29d and 29e having different diameters. Thus, the number of parts can be reduced.

The support portion 28c is included in the second attachment member having the support portion 33. Since the support portion 28c can be attached after the reflection sheet 29 is arranged, the arranging work for the reflection sheet 29 is easily performed. If the support portion 28c is included in the first attachment member 31, the projected support portion 28c may be an obstruction in arrangement work for the reflection sheet 29. According to the configuration of this embodiment, the projected support portion 28c does not obstacle for arranging the reflection sheet 29.

Each LED board 25 is fixed to the chassis 22 with two first attachment members 31. First, the LED boards 25 are fixed to the chassis 22 with the first attachment members 31. Then, the reflection sheet 29 and the LED boards 25 are fixed to the chassis 22 with the second attachment members 32. In this attachment procedure, each LED board 25 can be fixed to the chassis 22 without being shifted from the arranged position by the first attachment member 31. Further, the number of the first reflection sheet insertion holes 29d, which may be recognized as dark spots, can be reduced to the minimum necessary.

### Second Embodiment

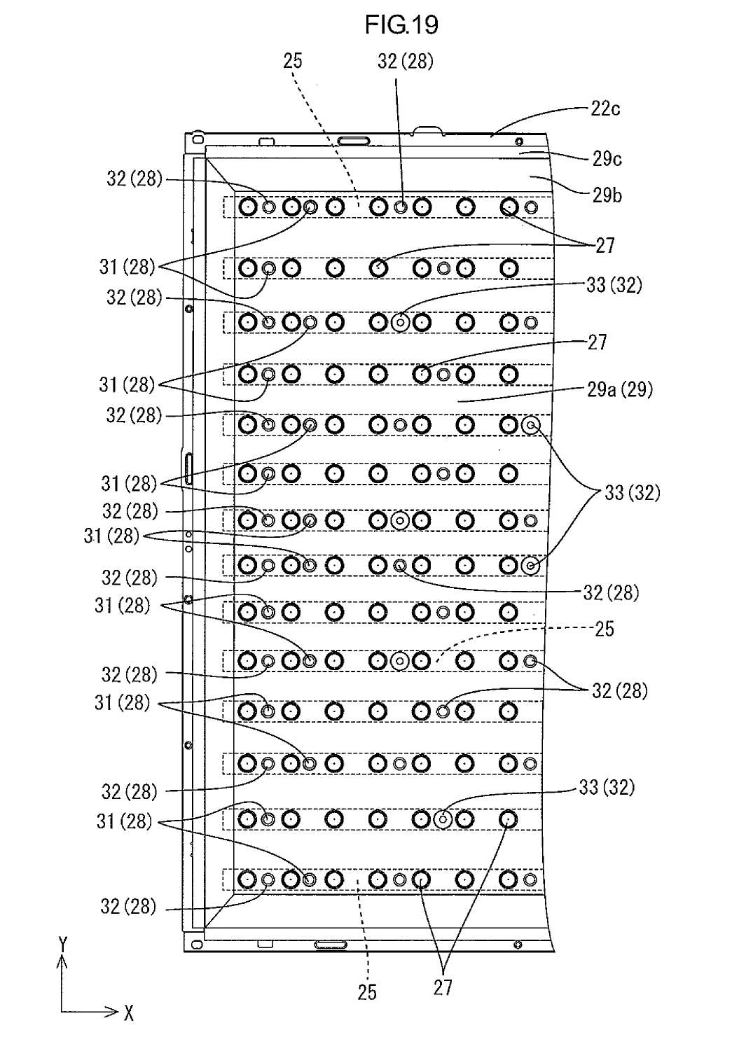

A second embodiment of this invention will be described with reference to FIG. 19. The arrangement of the first attachment members 31 in the arranging direction of the LED boards 25 (the Y-axis direction) is changed from the first embodiment. Other configurations are the same as the first embodiment. The same parts as those in the first embodiment will be indicated by the same symbols and will not be explained.

The first attachment members 31 are arranged so as to be in a staggered position to one another on the adjacent LED boards 25 arranged along the arranging direction of the LED boards 25 (the Y-axis direction). Specifically, fourteen LED boards 25 are arranged in the left column, which is located at the left edge of the chassis 22. The LEDs 24 are arranged in the columns and rows on the LED boards 25. Each of the first, third, fifth, and seventh LED boards 25 from the top among the fourteen LED boards 25, the first attachment member 31 is arranged between the second and the third LEDs 24 from the left end of each LED 25. Each of the second, fourth, sixth LED boards 25 from the top, the first attachment member 31 is arranged between the first and the second LEDs 24 from the left end of each LED 25. Therefore, the LED board 25 including the first attachment member 31 between the second and the third LEDs 24 from the left end and the LED board 25 including the first attachment member 31 between the first and the second LEDs 24 from the left end are repeatedly arranged from the top. As a result, the first attachment members 31 are arranged in a staggered position.

As illustrated in FIG. 19, in the fourteen LED boards 25 in the left column, seven LED boards 25 from the bottom have the same arrangement as the top seven of the LED boards 25 if the order of the top seven LED boards 25 is turned upside down. Thus, the detail configuration thereof will not be explained. The first attachment members 31 arranged in the middle area of the chassis 22 in the X-axis direction and the first attachment members 31 arranged in the right side of the chassis 22 have the same arrangement configuration (not illustrated).

According to this embodiment, the first attachment members 31 on the adjacent LED boards 25 arranged along the arranging direction of the LED boards 25 (the Y-axis direction) are in a staggered position. Thus, the first attachment members 31 are less likely to be arranged close to each other in the Y-axis direction and the reflection sheet insertion holes 29d, which may cause dark spots, are also less likely to be arranged close to each other. Therefore, uneven brightness, which may be caused the first reflection sheet insertion holes 29d, is less likely to occur.

### Third Embodiment

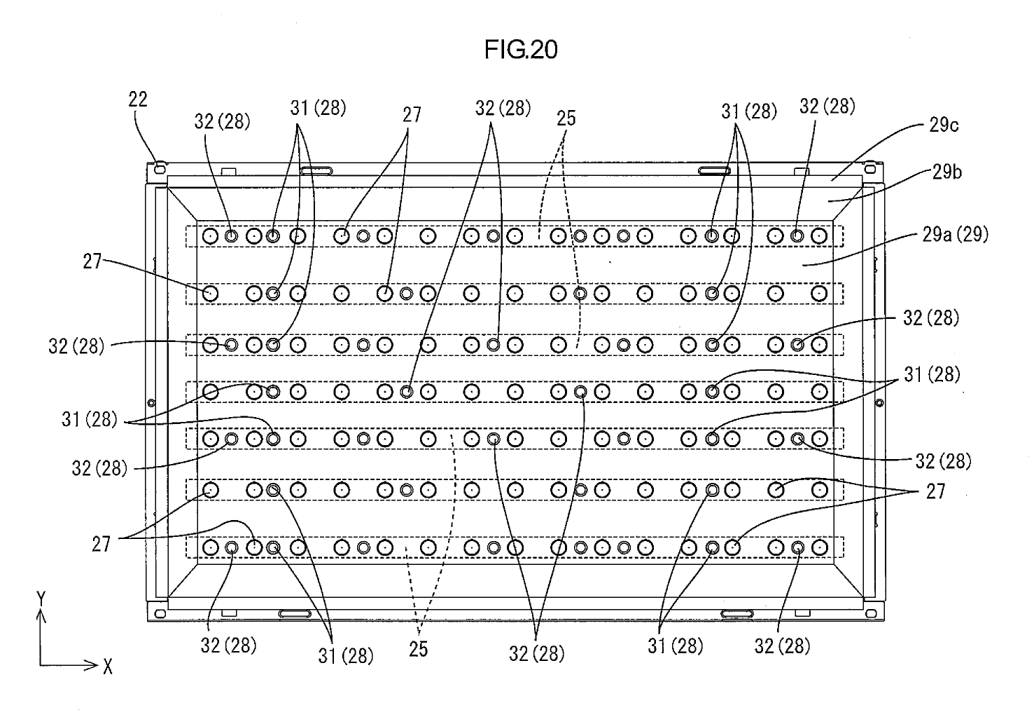

A third embodiment of this invention will be described with reference to FIG. 20. In this embodiment, only one LED board 25 is arranged along the arranging direction of the LEDs 24 (the X-axis direction). Specifically, one LED board 25 in the X-axis direction and seven LED boards 25 in the Y-axis direction are arranged in the chassis 22. Furthermore, the second attachment member 32 does not include the second attachment member having the support portion 33. Other configurations are the same as the first embodiment. The same parts as those in the first embodiment will be indicated by the same symbols and will not be explained.

In this embodiment, the second attachment members 32 are arranged closer to the end portions of each LED board 25 than the first attachment members 31 in each of the first, third, fifth, and seventh LED boards 25 from the top. Therefore, uneven brightness that may be caused by the first attachment members 31 is less likely to occur. In general, if the reflection sheet 29 is fluctuated, the reflection sheet 29 reflects light to different directions and this may cause uneven brightness in the backlight unit 12. The edge portions of the reflection sheet 29 are more likely to lift from the chassis 22 and this uplift may be a factor of fluctuation. In this embodiment, the second attachment members 32 are located at the end portions of one LED board 25 arranged in the X-axis direction. Therefore, the reflection sheet 29 is fixed to the chassis 22 at parts corresponding to the edge portions of the chassis 22 with the second attachment members 32. Accordingly, the uplift of the reflection sheet 29 from the edge portions of the chassis 22 can be suppressed or less likely to occur.

In this embodiment, the second attachment member 32 does not include the second attachment member having a support potion 33. The first attachment member 31 and the second attachment member 32 have the same configuration, namely, each include the first piece 35 and the second piece 36. Therefore, the same first and second pieces 35 and 36 can be used for the first and second attachment members 31 and 32 only by providing the first and second reflection sheet insertion holes 29d and 29e having different diameters. Thus, the number of parts can be reduced.

### Other Embodiments

The present invention is not limited to the above embodiments explained in the above description and the drawings. The technology described herein may include the following embodiments.

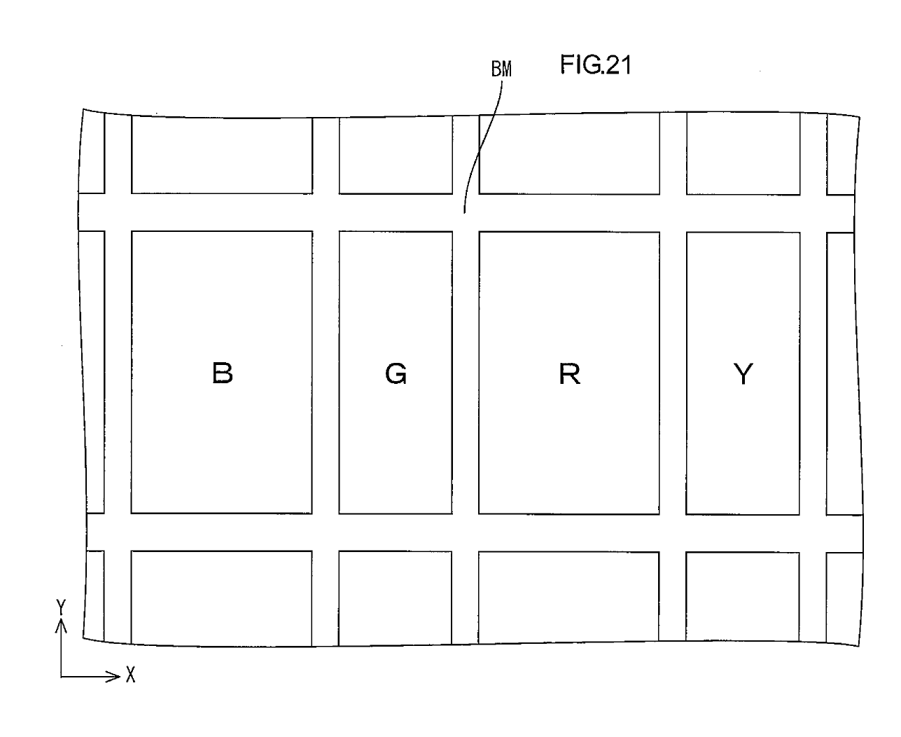

(1) In addition to the above embodiments, the arrangement of the color portions of the color filter included in the liquid crystal panel may be suitably changed. For example, as illustrated in FIG. 21, the R, G, B, and Y color portions included in the color filters may be arranged in the X-axis direction in an order of: the B color portion in blue, the G color portion in green, the R color portion in red, and the Y color portion in yellow, from the left in FIG. 21.

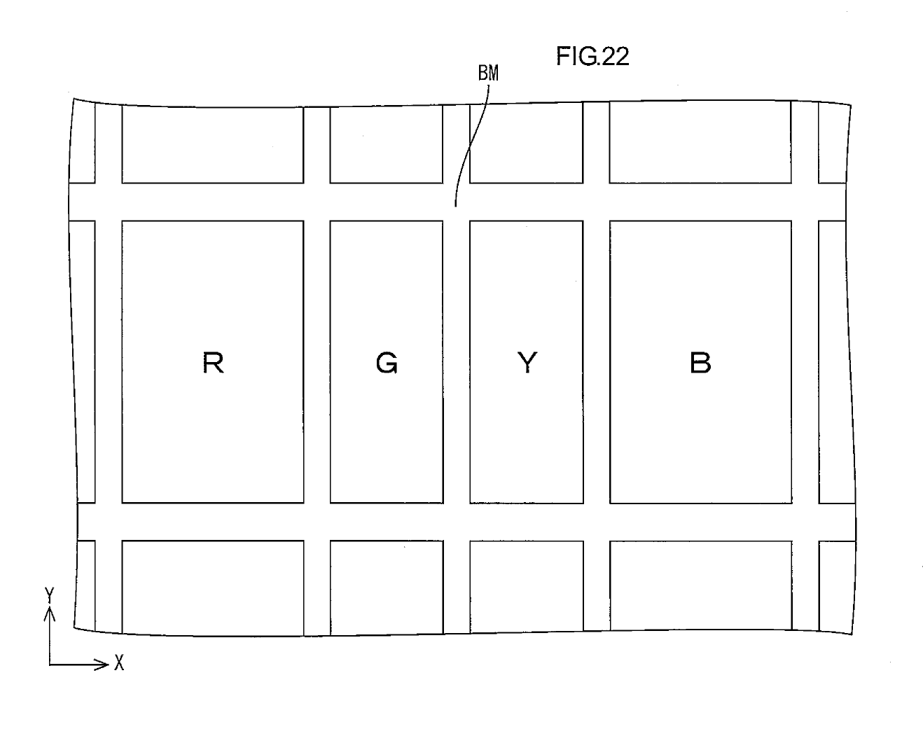

(2) In addition to the above (1), as illustrated in FIG. 22, the R, G, B, and Y color portions included in the color filters may be arranged in the X-axis direction in an order of: the R color portion in red, the G color portion in green, the Y color portion in yellow, and the B color portion in blue, from the left in FIG. 22.

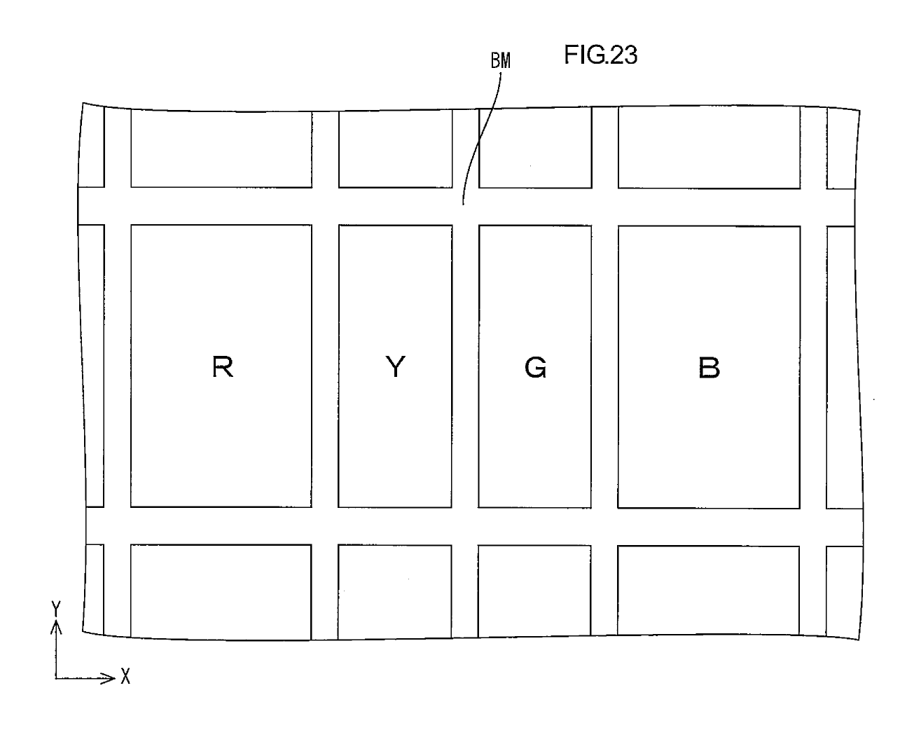

(3) In addition to the above (1) and (2), as illustrated in FIG. 23, the R, G, B, and Y color portions included in the color filters may be arranged in the X-axis direction in an order of: the R color portion in red, the Y color portion in yellow, the G color portion in green, and the B color portion in blue, from the left in FIG. 23.

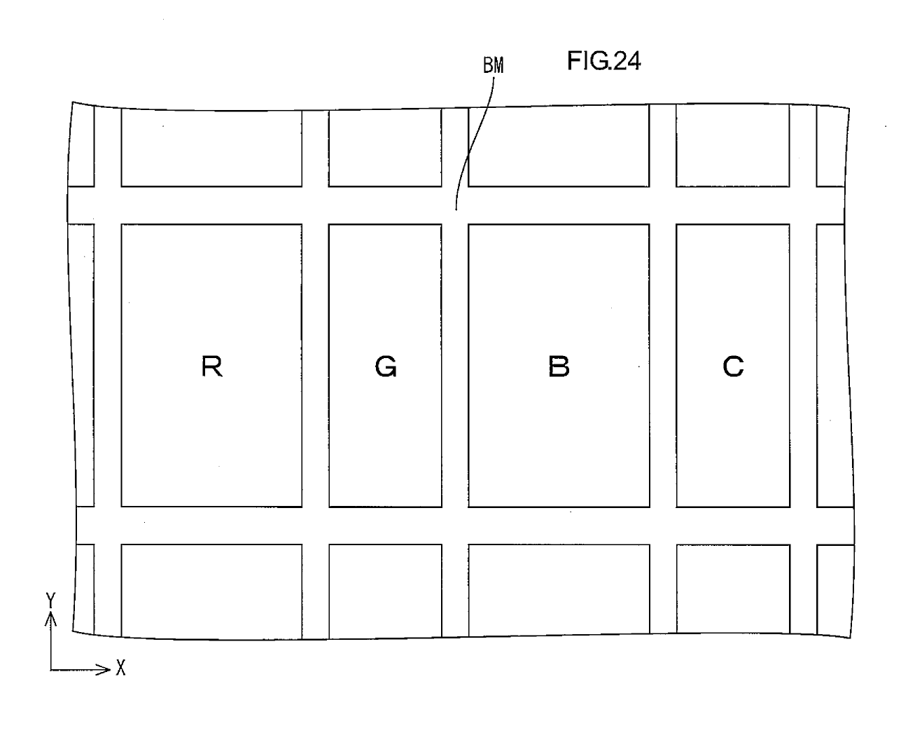

(4) In the above embodiments, the color filters include the Y color portions in addition to the R color portions, the G color portions, and the B color portions as the three primary colors of light. However, the color filters may include C color potions in cyan instead of the Y color portions in yellow, as illustrated in FIG. 24.

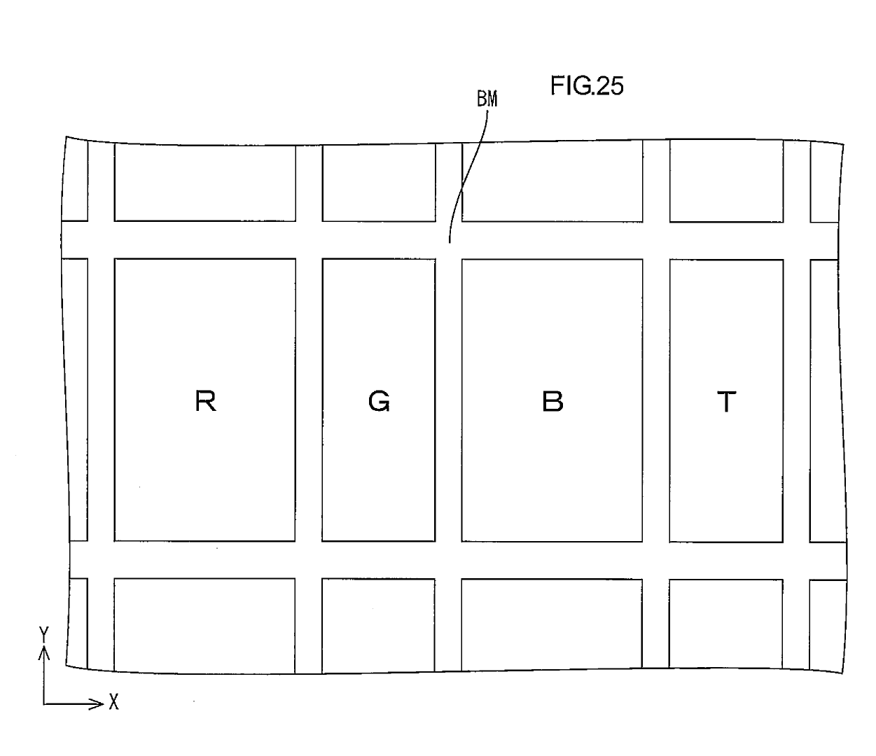

(5) In the above embodiments, the color filters include four color portions. However, transparent portions T that do not color the transmitted light may be replaced with the yellow color portions as illustrated in FIG. 25. The transparent portions T have equal light transmissivity for at least the visible light range in all wavelength regions. Thus, the transmitted light is not colored to any specific color.

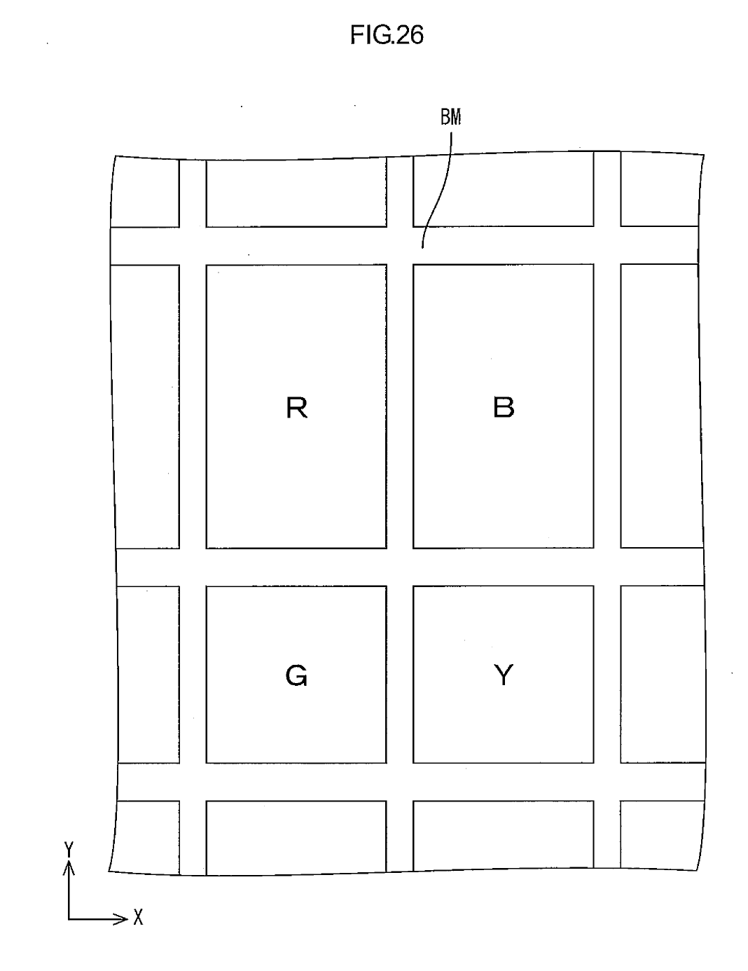

(6) In the above embodiments, four of the R, G, B and Y color portions are arranged in the row direction. However, the four of the R, G, B, are Y color portions may be arranged in the column and row directions. Specifically, as illustrated in FIG. 26, the four of the R, G, B, and Y color portions are arranged in the X-axis direction as the row direction and the Y-axis direction as the column direction, respectively. Each of the color portions R, G, B, and Y has the same length in the row direction and has a different length from one another in the column direction (the Y-axis direction). In the row having a relatively larger length in the column direction than another row, the R color portions in red and the B color portions in blue are arranged adjacent to each other in the row direction. In the row having a relatively smaller length in the column direction than the other row, the G color portions in green and the Y color portions in yellow are arranged adjacent to each other in the row direction. Namely, a first row having the R color portions in red and the B color portions in blue and a second row having the G color portions in green and the Y color portions in yellow are repeatedly arranged in the column direction. The first row has a length relatively larger than at of the second row in the column direction. The R color portions in red and the B color portions in blue are repeatedly arranged in the row direction. The second row has a length relatively smaller than that of the first row in the column direction, and the G color portions in green and the Y color portions in yellow are repeatedly arranged in the row direction. Namely, the R color portions in red and the B color portions have larger areas than those of the G color portions in green and the Y color portions. The R color portion in red and the G color potion in green are arranged adjacent to each other in the column direction, and the B color portion in blue and the Y color portion in yellow are arranged adjacent to each other in the column direction.

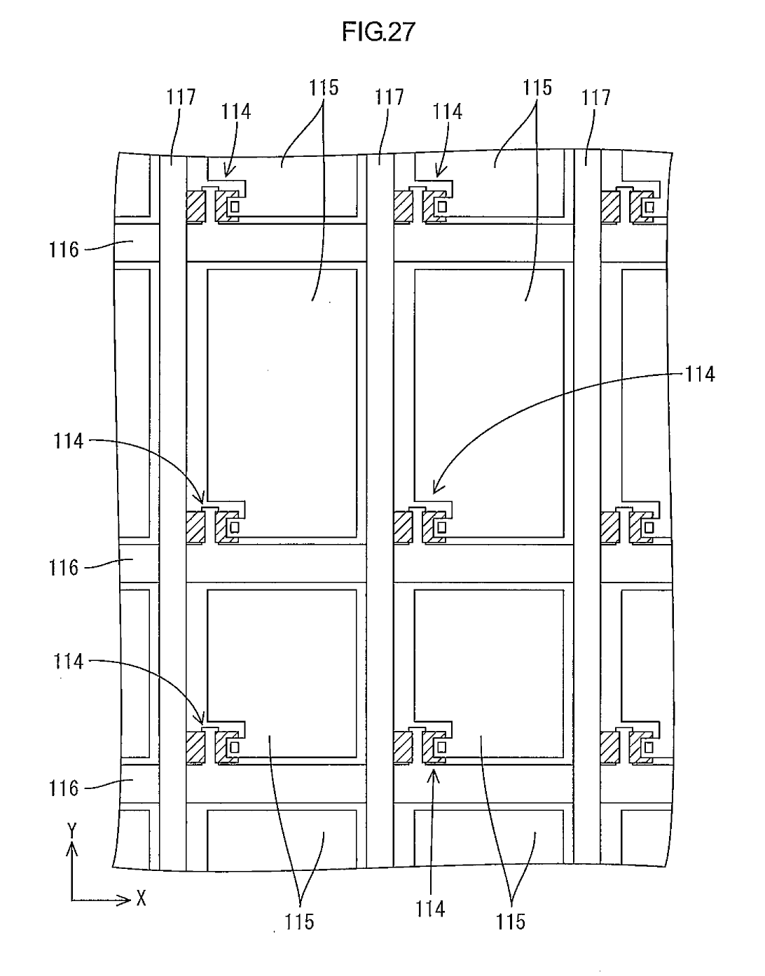

According to the color filters having the above configuration, dimensions of pixel electrodes 115 on the array board that measure in the column direction are different from row to row as illustrated in FIG. 27. Namely, areas of the pixel electrodes 115 overlapping the R color portions in red and the B color portions in blue are relatively larger than those of the pixel electrodes 115 overlapping the Y color portions in yellow and the G color portions in green. Further, each of the R, G, B, and Y color portions has the same film thickness. Source lines 117 are arranged at equal intervals and gate lines 16 are arranged at two different intervals corresponding to the dimensions of the pixel electrodes 115 that measure in the column direction. FIGS. 26 and 27 each show that the area of each of the R color portions in red and the B color portions in blue is 1.6 times larger than the area of each of the Y color portions in yellow and the G color portions in green.

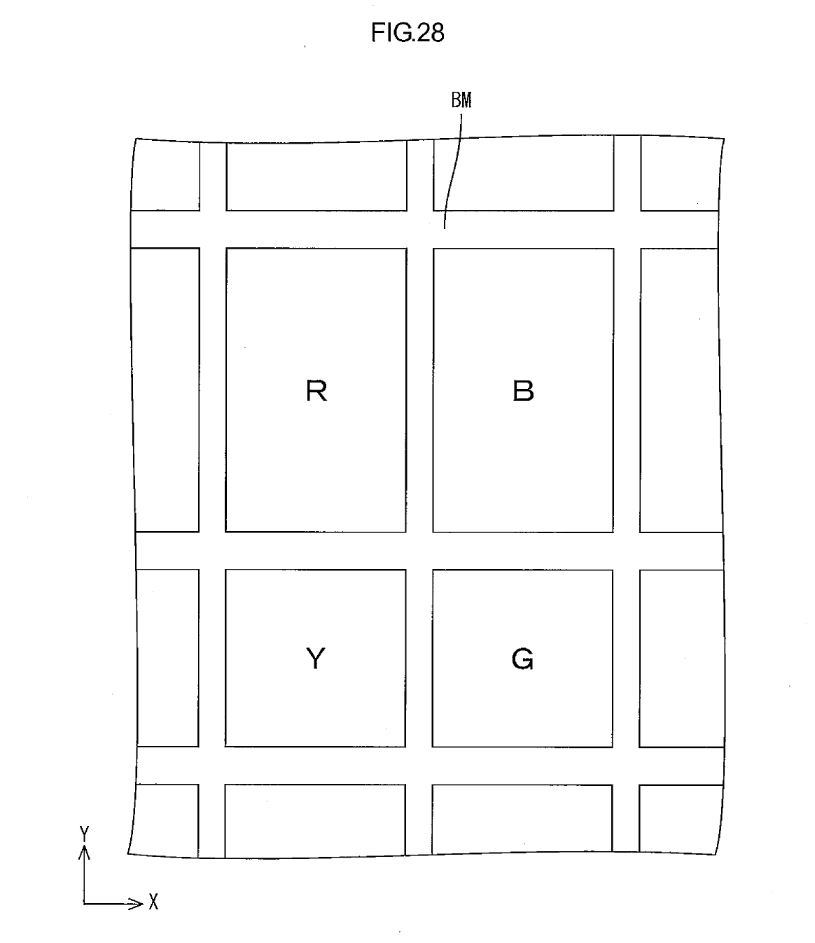

(7) As a modification of the above (6), as illustrated in FIG. 28, the R color potion in red and the Y color portion in yellow can be arranged adjacent to each other in the same column while the B color portion in blue and the G color portion in green may be arranged adjacent to each other in the same column.

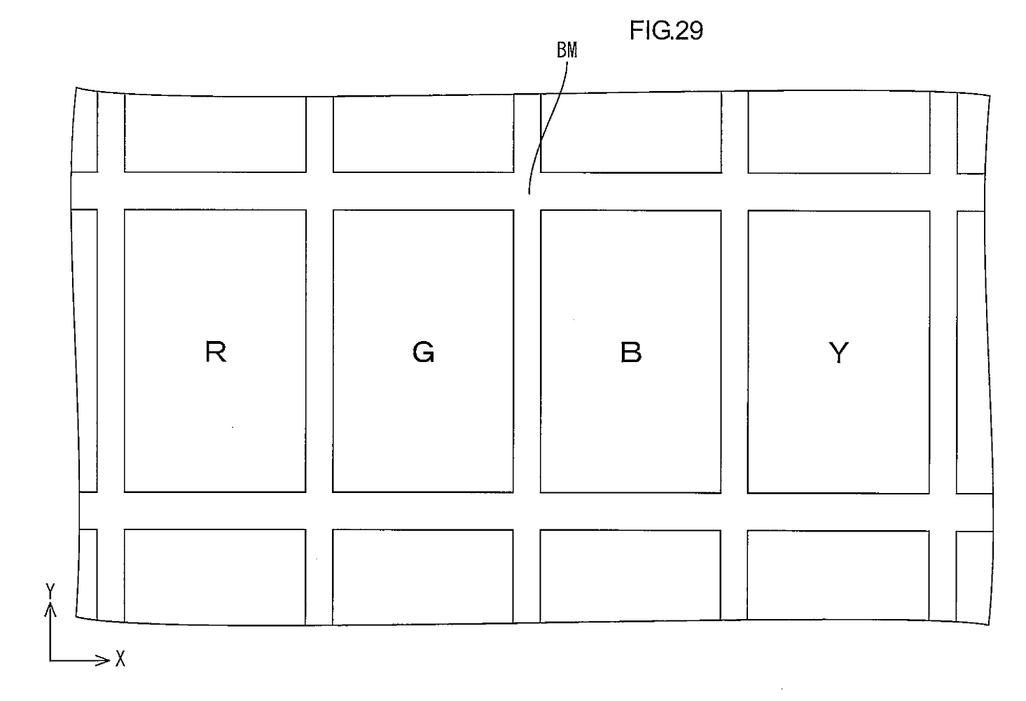

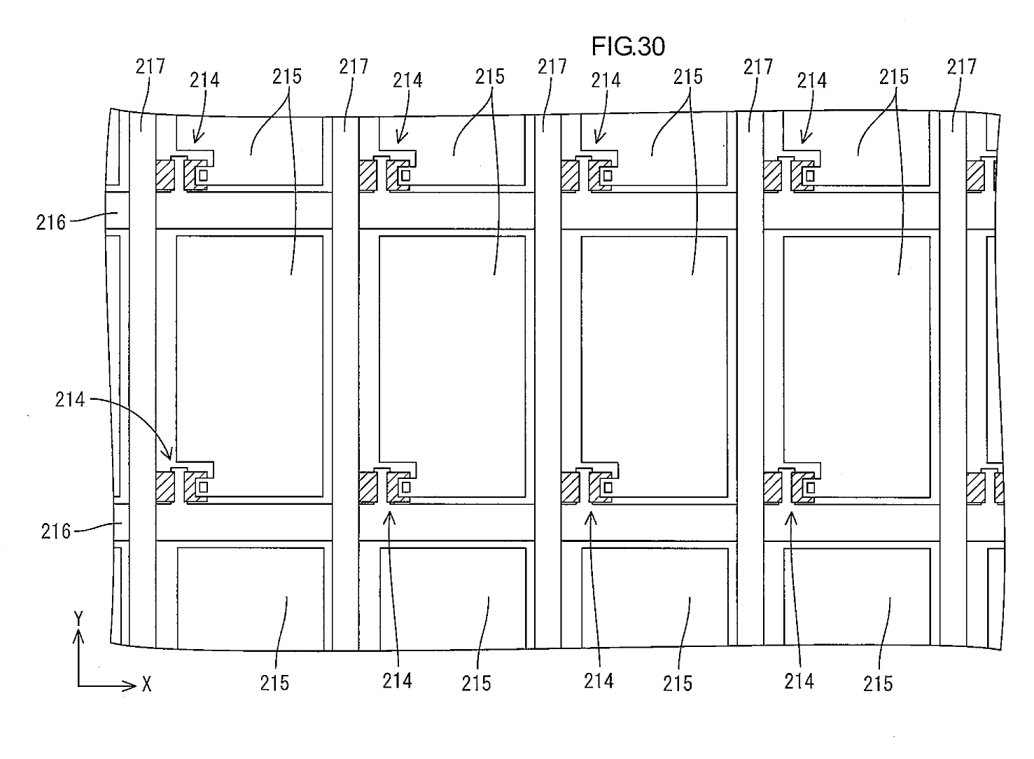

(8) In the above embodiments, the area ratio of the R, G, B, and Y color portions in the color filters are unequal. However, the area ratio of the R, G, B, and R color portions may be equal. Specifically, the R, G, B, and Y color portions are arranged in a grid as illustrated in FIG. 29. The X-axis direction is a row direction. The Y-axis direction is a column direction. Dimensions of the R, G, B, and Y color portions that measure in the row direction (the X-axis direction) are the same. Dimensions of the R, G, B, and Y color portions that measure in the column direction (the Y-axis direction) are also the same. Namely, the R, G, B, and Y color portions have the same area size. According to the color filters of the above configuration, dimensions of pixel electrodes 215 on the array board each corresponding to each of the R, G, B, and Y color portions that measure in the row direction are equal as illustrated in FIG. 30. Further, dimensions of pixel electrodes 215 on the array board each corresponding to each of the R, G, B, and Y color portions that measure in the column direction are also equal. Accordingly, all of the pixel electrodes 215 have the same shape and the same area size. Gate lines 216 and source lines 217 are arranged at equal intervals.

(9) The arrangement of the R, G, B, and Y color portions in (8) may be same as any one of those in (1) to (3).

(10) Each of the configurations explained in (4) and (5) may apply to the above (6) and (8).

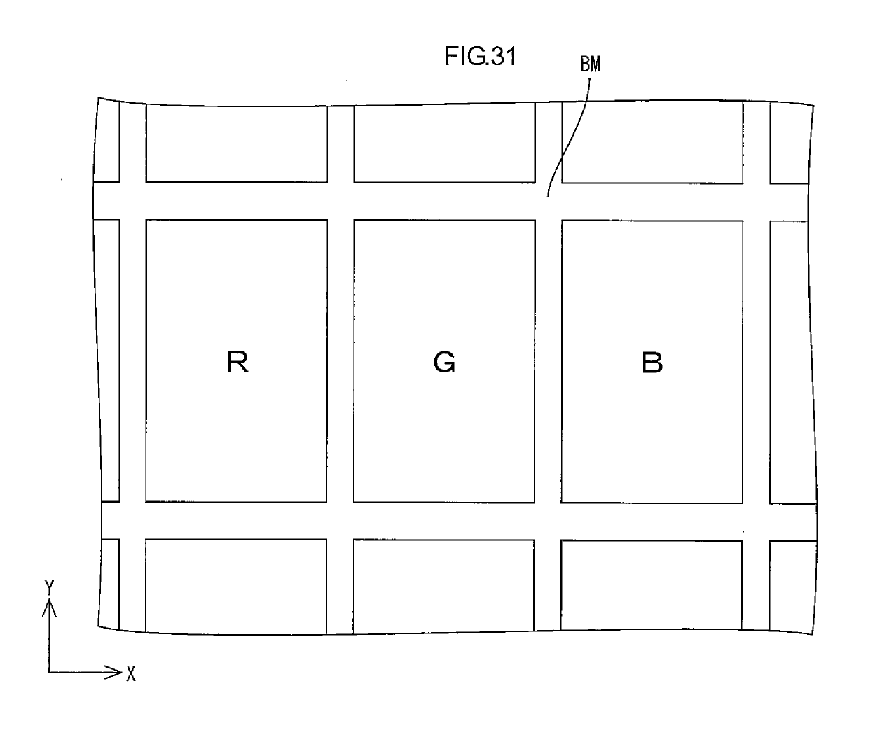

(11) In the above embodiments, the color portions of the color filters are four colors. However, as illustrated in FIG. 31, the color portions only having the R color portions in red, the G color portions in green, and the B color portions in blue as the three primary colors of light without the Y color portions in yellow may be used. In such a case, the R, G, and B color portions having the same area ratio is preferable.

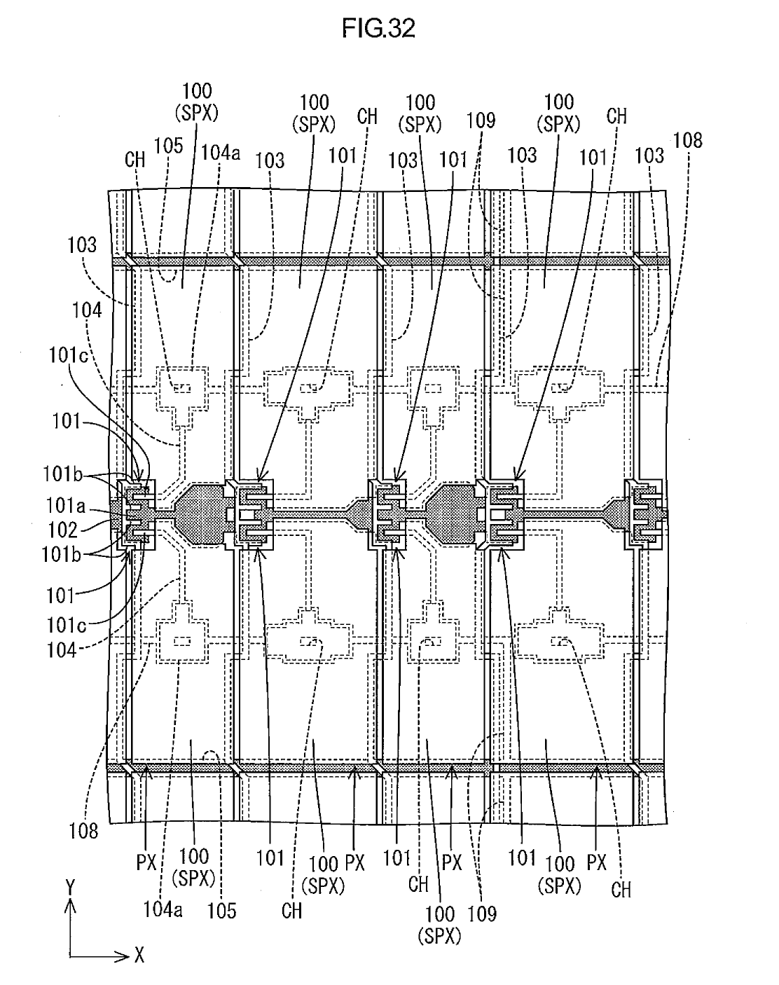

(12) The configurations of the pixels in the above embodiments are explained with reference to the simple figures (FIGS. 4 and 5). However, specific configurations of the pixels may be altered from the configurations illustrated in the figures. For example, the scope of the present invention can be applied to configuration in which the pixels are driven by so-called multi pixel drive, that is, a single pixel is divided into a plurality of sub pixels and the sub pixels are driven such that the sub pixels are at different gradation levels from one another. Specifically, as illustrated in FIG. 32, each pixel PX includes a pair of sub-pixels SPX. The pair of sub-pixels SPX is configured with a pair of pixel electrodes 100 that are adjacent to each other with a gate line 102 therebetween. A pair of TFTs 101 arranged on the gate line 102 corresponds to the pair of pixel electrodes 100. The pair of TFTs 101 is arranged on the gate line 102 along an arranging direction of the pair of sub pixels SPX that configures one pixel PX (Y-axis direction). Each one of the TFTs 101 includes a gate electrode 101a, a pair of source electrodes 101b, and a drain electrode 101c. The gate electrode 101a is a part of the gate line 102. The source electrodes 101b are a pair of branch lines branched from a source line 103 and arranged on the gate electrode 101a. The drain electrode 101c is arranged on the gate electrode 101a and located between the pair of source electrodes 101b. The drain electrode 101c of each TFT 101A drain line 104 is connected to a drain line 104. The drain line 104 includes a contact portion 104a on one side and the drain electrode 101a is connected to the other side of the drain line 104. The contact portion 104a is connected to each pixel electrode 100. Each contact portion 104a and the corresponding pixel electrode 100 are connected via a contact hole CH formed through an interlayer insulating film (not illustrated) therebetween. The contact portion 104a and the pixel electrode 100 are unipotential. On the other hand, auxiliary capacitance lines 105 are arranged at sides of the pair of pixel electrodes 100 opposite the gate line 102 sides. Each auxiliary capacitance line 105 is arranged so as to overlap with the pixel electrode 100 in a plan view and forms a capacitance with the overlapped pixel electrode 100. Namely, a capacitance appears between one of the pair of pixel electrodes 100 in one pixel PX and one of auxiliary capacitance lines 105, and a capacitance appears between the other one of the pair of pixel electrodes 100 and the other one of auxiliary capacitance lines 105. Further, in-pixel auxiliary capacitance lines 108 are provided between and parallel to the gate line 101 and each auxiliary capacitance lines 105 so as to be across each pixel electrode 100 and contact portion 104a. Each in-pixel auxiliary capacitance line 108 is connected to the auxiliary capacitance line 105, which is an opposite side from the gate line 101 side, via a connection line 109. Thus, the in-pixel auxiliary capacitance lines 108 and the respective auxiliary capacitance lines 105 are unipotential. Therefore, a capacitance appears between the in-pixel auxiliary capacitance line 108 having the same potential with the auxiliary capacitance line 105 and the contact portion 104a having the same potential with the overlapped pixel electrode 100 in the plan view. The pair of TFTs 101 is driven by feeding drive signals and data signals via the common gate line 102 and source line 103. On the other hand, different signals (potentials) are fed to each of the pair of the pixel electrodes 100 and each contact portion 104a connected to the corresponding pixel electrode 100, each auxiliary capacitance line 105 overlaps with the corresponding pixel electrode 100, and each in-pixel auxiliary capacitance line 108 corresponding to each pixel electrode 100. Therefore, the sub pixels SPX can be charged with different voltages, that is, the sub pixels SPX can have different gradation levels. Accordingly, the multi pixels drive can be performed and can provide high viewing angle property.

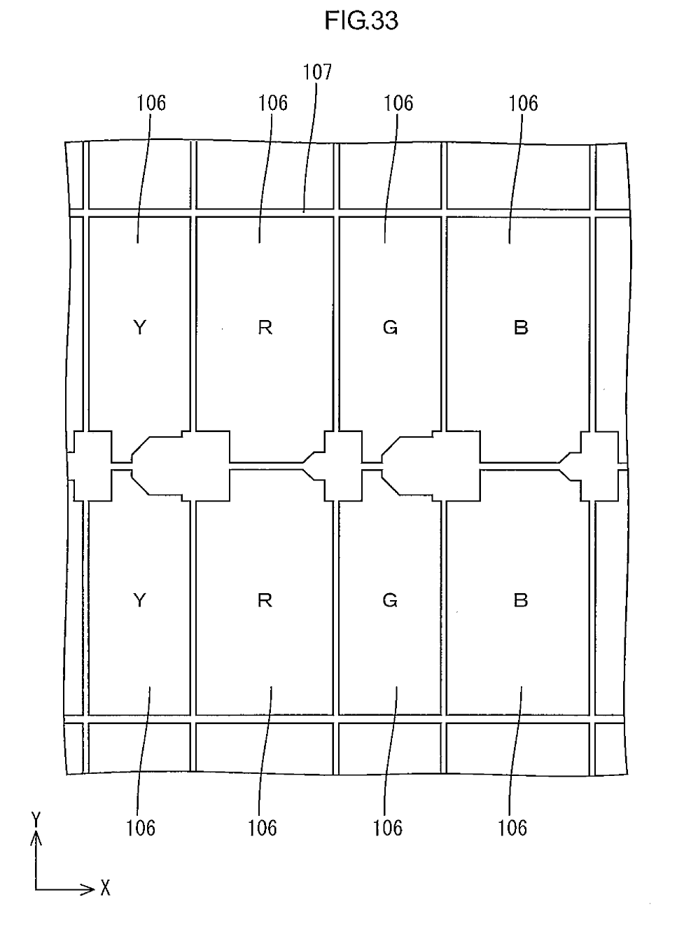

Followings are configurations of the pixels used for the above multi pixel drive. The pixels include the pixel electrodes 100 and R, G, B, and Y color portions of color filters 106 that correspond to the respective pixel electrodes 100. As illustrated in FIG. 33, the color filters 106 include the color portions in four colors, that is, the R, G, B, and Y color portions. The color filters are repeatedly arranged in lines in the X-axis direction in an order of: the Y color portion in yellow, the R color portion in red, the G color portion in green, and the B color portion in blue, from the left in FIG. 33. Each of the R, G, B, and Y color portions are segmented by a light blocking layer 107 (a black matrix). The light blocking layer 107 is provided in a grid so as to overlap with the gate line 102, the source lines 103, and the auxiliary capacitance lines 105 in a plan view. In the R, G, B, and Y color portions, dimensions of the Y color portions in yellow and the G color portions in green that measure in the X-axis direction (an arranging direction of the R, G, B, and Y color portions) are substantially equal. On the other hand, dimensions of the R color portions in red and the B color portions in blue that measure in the X-axis direction are larger relative to those of the Y color portions in yellow and the G color portions in green (1.3 to 1.4 times larger, for example). More specifically, a dimension of the R color portion in red that measures in the X-axis direction is slightly larger than that of the B color portion in blue. As illustrated in FIG. 33, dimensions of the pixel electrodes 100 that measure in the Y-axis direction are the substantially equal. Dimensions of the pixel electrodes 100 that measure in the X-axis direction correspond to the respective R, G, B, and Y color portions.

(13) In the above embodiments, the plurality of LEDs are arranged in line on each LED board having the landscape rectangular shape. However, a plurality of LEDs may be arranged in a grid on an LED board. Specifically, an LED board on which LEDs are arranged in a matrix with two rows and two columns or with three rows and three columns may be used. Further, LEDs may be arranged in a staggered position.

(14) In the above embodiments, one or two LED boards 25 are arranged in the X-axis direction in the backlight unit. However, three or more LED boards 25 may be arranged in the X-axis direction.

(15) In the above embodiments, the first attachment members 31 and the second attachment members 32 each are configured with two pieces. However, one piece or three or more pieces may be included in each attachment member.

(16) In the above embodiments, the first attachment members 31 that are arranged in a staggered position are included in an embodiment. The first attachment members 31 that are arranged in line in the Y-axis direction are includes in another embodiment. However, those arrangements may be included in one backlight unit. For example, the first attachment members 31 may be arranged in line at the edge side of the chassis 22 and arranged in a staggered position at the middle area of the chassis 22.

### EXPLANATION OF SYMBOLS

10: liquid crystal display device (display device), 11: liquid crystal panel (display panel), 12: backlight unit (lighting device), 22: chassis, 22d: mounting hole, 23: optical member, 24: LED (light source), 25: LED board (board), 25c: first board insertion hole, 25d: second board insertion hole, 28: holding member (first attachment member, second attachment member), 28a: main body (first head portion, second head portion), 28b: fixing portion (first axial portion, second axial portion), 28c: support portion, 29: reflection sheet, 29d: first reflection sheet insertion hole, 29e: second reflection sheet insertion hole, 31: first attachment member, 31a: first head portion, 31b: first axial portion, 32: second attachment portion, 32a: second head portion, 32b: second axial portion, 33: attachment member having a support portion, 35: first piece (piece), 36: second piece (piece), TV: television device

1. A lighting device comprising:
a plurality of light sources;
a board including the light sources being mounted on one of surfaces thereof and arranged along an arranging direction of the light sources, the board having a first board insertion hole and a second board insertion hole, the second board insertion hole being arranged closer to an end portion of the board in the arranging direction of the light sources than the first board insertion hole;
a reflection sheet arranged on the one of the surfaces of the board, the reflection sheet having a first reflection sheet insertion hole and a second reflection sheet insertion hole, the first reflection sheet insertion hole being arranged at a position that overlaps with the first board insertion hole and having a diameter larger than a diameter of the first board insertion hole, the second reflection sheet insertion hole being arranged at a position that overlaps with the second board insertion hole;
a chassis housing the board and the reflection sheet;
a first attachment member for fixing the board to the chassis, the first attachment member having a first axial portion and a first head portion, the first axial portion being passed through the first board insertion hole and fixed to the chassis, the first head portion having a diameter larger than the diameter of the first board insertion hole and smaller than the diameter of the first reflection sheet insertion hole, the first head portion being fixed at a hole edge of the first board insertion hole; and
a second attachment member for fixing the reflection sheet and the board to the chassis, the second attachment member having a second axial portion and a second head portion, the second axial portion being passed through the second reflection sheet insertion hole and the second board insertion hole and fixed to the chassis, the second head portion having a diameter larger than a diameter of the second reflection sheet insertion hole and being fixed at a hole edge of the second reflection sheet insertion hole.

2. The lighting device according to claim 1, wherein
the board further comprises a plurality of boards housed in the chassis, and
at least one of the boards arranged at a corner portion inside the chassis is attached to the chassis by the first attachment member and the second attachment member.

3. The lighting device according to claim 1, wherein
the second attachment member further includes a plurality of second attachment members, and
the boards are arranged along the arranging direction of the light sources and each of the boards is provided with the second attachment member that is arranged at an end portion thereof opposite an end portion of an adjacent board arranged along the arranging direction of the light sources.

4. The lighting device according to claim 1, wherein
the boards are arranged perpendicular to the arranging direction of the light sources,
the first attachment member further includes a plurality of first attachment members and each one of the first attachment members is arranged to each one of the boards such that the first attachment members are in line with each other in an arranging direction of the boards.

5. The lighting device according to claim 1, wherein
the boards are arranged perpendicular to the arranging direction of the light sources,
the first attachment member further includes a plurality of first attachment members and the first attachment members are arranged to the adjacent boards along the arranging direction of the boards such that the first attachment members are in a staggered position with each other.

6. The lighting device according to claim 1, wherein each of the first attachment members and the second attachment members has a same configuration and includes a same piece.

7. The lighting device according to claim 1, further comprising an optical member arranged opposite the reflection sheet to diffuse light, wherein the second attachment member includes a second attachment member having a support portion.

8. The lighting device according to claim 1, wherein the board is attached to the chassis with two of the first attachment members.

9. A display device comprising:
the lighting device for a display device according to claim 1; and
a display panel arranged on a front side of the lighting device for the display device.

10. The display panel according to claim 9, wherein the display panel is a liquid crystal panel including liquid crystals sealed between a pair of substrates.

11. A television device comprising the display device according to claim 9.
